(19) United States
(12) Patent Application Publication
(10) Pub. No.: US 2022/0296975 A1
(43) Pub. Date: Sep. 22, 2022

(54) HOCKEY STICK OR OTHER SPORTING IMPLEMENT

(71) Applicant: Bauer Hockey Ltd., Blainville (CA)

(72) Inventors: Thierry Krick, Coteau-du-Lac (CA); Jean-Francois Laperriere, Prevost (CA); Edouard Rouzier, Montreal (CA)

(21) Appl. No.: 17/612,553

(22) PCT Filed: May 21, 2020
(86) PCT No.: PCT/CA2020/050686

§ 371 Date: Nov. 18, 2021

Related U.S. Application Data
(60) Provisional application No. 62/881,687, filed on Aug. 1, 2019.
(60) Provisional application No. 62/850,831, filed on May 21, 2019.

(51) Int. Cl. A63B 59/70; B33Y 80/00

(52) U.S. Cl. CPC A63B 59/70; B33Y 80/00; A63B 2209/02; A63B 59/20

(57) ABSTRACT

A hockey stick or other sporting implement designed to enhance its use, performance and/or manufacturing, including, for example, by being lightweight, having improved strength, flex, stiffness, impact resistance and/or other properties, reducing scrap waste during its construction, and/or enhancing other aspects of the hockey stick or other sporting implement. For instance, in some embodiments, the hockey stick or other sporting implement may include a structure that is open, such as by being latticed (e.g., trussed), and/or made by additive manufacturing, selective material positioning, etc.

### CROSS-REFERENCE TO RELATED APPLICATIONS

This application claims the benefit of U.S. Provisional Patent Application No. 62/850,831 filed May 21, 2019 and U.S. Provisional Patent Application No. 62/881,687 filed Aug. 1, 2019, the entire contents of which are incorporated by reference herein.

### FIELD

This disclosure relates to sporting implements and, more particularly, to hockey sticks and other sporting implements (e.g., lacrosse sticks).

### BACKGROUND

Sporting implements are used in various sports to strike, propel, or otherwise move a puck, ball, or other object.

For example, in hockey, a player uses a hockey stick to move, pass, and shoot a puck or ball during a game. Notably, the hockey stick comprises a shaft for holding by the player and a blade for handling the puck or ball.

Hockey sticks are often desired to be lightweight and have various properties, such as strength, stiffness, flex, impact resistance, etc., which can sometimes be conflicting, require tradeoffs, or not be readily feasible, for cost, material limitations, manufacturability, and/or other reasons.

Similar issues often arise in other sports, such as lacrosse, in which users use sticks or other sporting implements.

For these and other reasons, there is a need for improvements in hockey sticks and other sporting implements.

### SUMMARY

According to various aspects, this disclosure relates to a hockey stick or other sporting implement designed to enhance its use, performance and/or manufacturing, including, for example, by being lightweight, having improved strength, flex, stiffness, impact resistance and/or other properties, reducing scrap or waste during its construction, and/or enhancing other aspects of the hockey stick or other sporting implement. For instance, in some embodiments, the hockey stick or other sporting implement may include a structure that is open, such as by being latticed (e.g., trussed), and/or made by additive manufacturing, selective material positioning, etc.

For example, according to one aspect, this disclosure relates to a hockey stick comprising: a blade; and a shaft to be held by a user. The hockey stick comprises a lattice including fiber-reinforced composite material.

According to another aspect, this disclosure relates to a hockey stick comprising: a blade; and a shaft to be held by a user. The hockey stick comprises a lattice including fiber-reinforced composite material and constituting at least part of the blade and at least part of the shaft.

According to another aspect, this disclosure relates to a hockey stick comprising: a blade; and a shaft to be held by a user. The hockey stick comprises a lattice including fiber-reinforced composite material; and a stiffness of the lattice is variable in a longitudinal direction of the hockey stick.

According to another aspect, this disclosure relates to a hockey stick comprising: a blade; and a shaft to be held by a user. The hockey stick comprises a lattice and a core disposed within the lattice.

According to another aspect, this disclosure relates to a hockey stick comprising: a blade; and a shaft to be held by a user. The hockey stick comprises an additively-manufactured component.

According to another aspect, this disclosure relates to a hockey stick comprising: a blade; and a shaft to be held by a user. The hockey stick comprises an additively-manufactured component comprising a plurality of distinct zones structurally different from one another.

According to another aspect, this disclosure relates to a hockey stick comprising: a blade; and a shaft to be held by a user. The hockey stick comprises a plurality of additively-manufactured components with different functions additively-manufactured integrally with one another.

According to another aspect, this disclosure relates to a hockey stick comprising: a blade; and a shaft to be held by a user. The hockey stick comprises an additively-manufactured component and a non-additively-manufactured component received by the additively-manufactured component.

According to another aspect, this disclosure relates to a method of making a hockey stick, the hockey stick comprising a blade and a shaft to be held by a user, the method comprising: providing feedstock; and additively manufacturing a component of the hockey stick using the feedstock.

According to another aspect, this disclosure relates to a lacrosse stick comprising: a head; and a shaft to be held by a user. The lacrosse stick comprises a lattice including fiber-reinforced composite material.

According to another aspect, this disclosure relates to a sporting implement comprising: an elongate holdable member configured to be held by a user; and an object-contacting member configured to contact an object intended to be moved by the user. The sporting implement comprises a lattice including fiber-reinforced composite material.

These and other aspects of this disclosure will now become apparent to those of ordinary skill upon review of a description of embodiments that follows in conjunction with accompanying drawings.

### BRIEF DESCRIPTION OF DRAWINGS

A detailed description of embodiments is provided below, by way of example only, with reference to accompanying drawings, in which:

FIG. 1 shows an embodiment of a sporting implement that is a hockey stick;

FIG. 2 is a top view of a bottom portion of a shaft of the hockey stick and a blade of the hockey stick;

FIG. 3 is a rear view of the bottom portion of the shaft of the hockey stick and the blade of the hockey stick;

FIG. 4 is an embodiment of a lattice comprised in the hockey stick;

FIG. 5 is a variant of the hockey stick;

FIG. 6 is a portion of the shaft of the hockey stick;

FIGS. 7 to 11 show examples of framework of the lattice;

FIGS. 12 and 13 show elongate members of the lattice forming a node in accordance with an embodiment;

FIGS. 14 and 15 show the elongate members of the lattice forming the node in accordance with another embodiment;

FIGS. 16 to 21 show cross-sectional shapes of the elongate members of the lattice in accordance with various embodiments;

FIGS. 22 to 27 show cross-sectional structures of the elongate members of the lattice in accordance with various embodiments;

FIGS. 28 shows a cross-section of a truss the lattice at the shaft of the hockey stick;

FIGS. 29 to 33 show variants of the cross-section of a truss the lattice at the shaft of the hockey stick;

FIGS. 34 to 37 show a cross-section of the shaft of the hockey stick in accordance with various embodiments;

FIGS. 38 and 39 show cross-sections of the blade of the hockey stick;

FIG. 40 shows an intersection between two zones of the lattice having different voxel sizes;

FIG. 41 shows two distinct non-hollow lattices having different voxel sizes;

FIG. 42 shows an intersection between two zones of the lattice having elongate members and/or nodes of different thicknesses (or different “struts size”);

FIG. 43 shows three distinct non-hollow lattices having elongate members and/or nodes of different thicknesses (or different “struts size”);

FIGS. 44A to 44H shows a manufacturing of the lattice in accordance with an embodiment;

FIG. 45 shows a variant of the lattice;

FIGS. 46 to 57 show variants of the hockey stick;

FIG. 58 shows another embodiment wherein the sporting implement is a goalie stick;

FIG. 59 shows another embodiment wherein the sporting implement is a lacrosse stick;

FIG. 60 shows another embodiment wherein the sporting implement is a ball bat; and

FIG. 61 shows an example of a test for determining the strength of the sporting implement.

It is to be expressly understood that the description and drawings are only for purposes of illustrating certain embodiments and are an aid for understanding. They are not intended to be and should not be limiting.

### DETAILED DESCRIPTION OF EMBODIMENTS

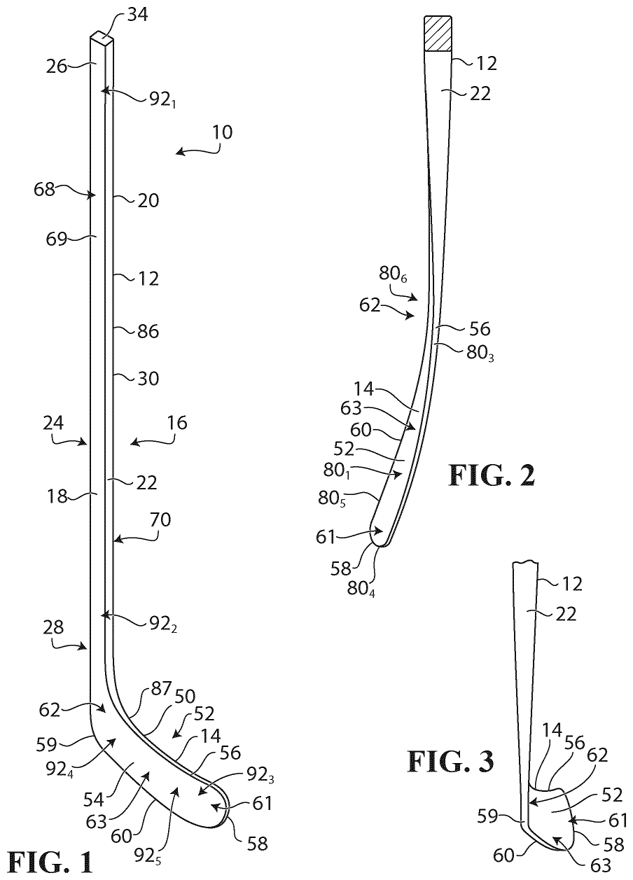

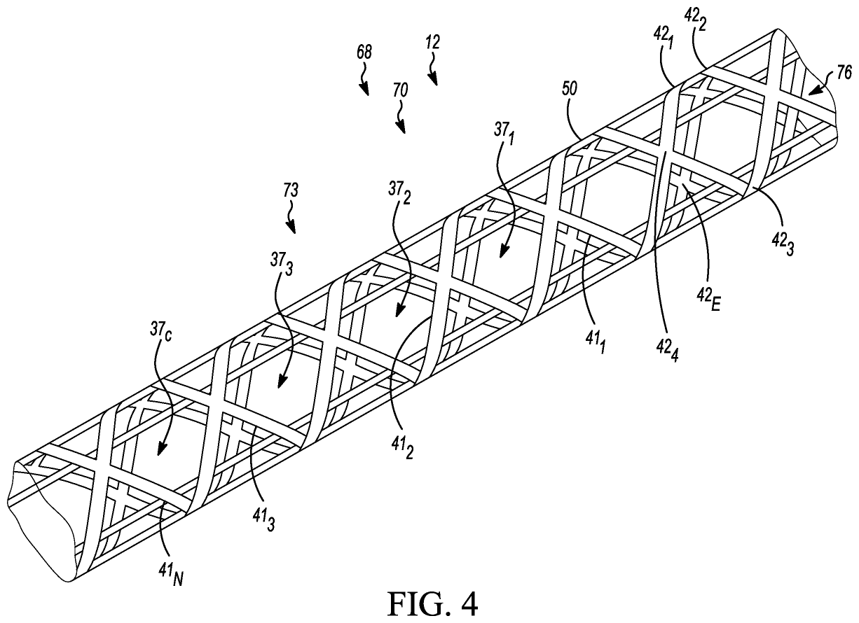

FIG. 1 shows an embodiment of a sporting implement 10 for use by a user engaging in a sport. The sporting implement 10 comprises an elongate holdable member 12 configured to be held by the user and an object-contacting member 14 configured to contact an object (e.g., a puck or ball) intended to be moved in the sport. In this embodiment, the sport is hockey and the sporting implement 10 is a hockey stick for use by the user, who is a hockey player, to pass, shoot or otherwise move a puck or ball. The elongate holdable member 12 of the hockey stick 10 is a shaft, which comprises a handle 20 of the hockey stick 10, and the object-contacting member 14 of the hockey stick 10 is a blade.

In this embodiment, as further discussed later, the hockey stick 10 is designed to enhance its use, performance and/or manufacturing, including, for example, by being lightweight, having improved strength, flex, stiffness, impact resistance and/or other properties, reducing scrap or waste during its construction, and/or enhancing other aspects of the hockey stick 10. For instance, in some embodiments, the hockey stick 10 may include a structure that is open, such as by being latticed (e.g., trussed), and/or made by additive manufacturing, selective material positioning, etc.

The shaft 12 is configured to be held by the player to use the hockey stick 10. A periphery 30 of the shaft 12 includes a front surface 16 and a rear surface 18 opposite one another, as well as a top surface 22 and a bottom surface 24 opposite one another. Proximal and distal end portions 26, 28 of the shaft 12 are spaced apart in a longitudinal direction of the shaft 12, respectively adjacent to the handle 20 and the blade 14, and define a length of the shaft 12. A length of the hockey stick 10 is measured from a proximal end 34 of the shaft 12 along the top surface 22 of the shaft 12 through the blade 14.

A cross-section of the shaft 12 may have any suitable configuration. For instance, in this embodiment, the cross-section of the shaft 12 has a major axis 36 which defines a major dimension D of the shaft's cross-section and a minor axis 38 which defines a minor dimension W of the shaft's cross-section. In this example, the cross-section of the shaft 12 is generally polygonal. More particularly, in this example, the cross-section of the shaft 12 is generally rectangular, with the front surface 16, the rear surface 18, the top surface 22, and the bottom surface 24 being generally flat. Corners between these surfaces of the shaft 12 may be rounded or beveled.

The shaft 12 may have any other suitable shape and/or be constructed in any other suitable way in other embodiments. For example, in some embodiments, the cross-section of the shaft 12 may have any other suitable shape (e.g., the front surface 16, the rear surface 18, the top surface 22, and/or the bottom surface 24 may be curved and/or angular and/or have any other suitable shape, possibly including two or more sides or segments oriented differently, such that the cross-section of the shaft 12 may be pentagonal, hexagonal, heptagonal, octagonal, partly or fully curved, etc.). As another example, the cross-section of the shaft 12 may vary along the length of the shaft 12.

The blade 14 is configured to allow the player to pass, shoot or otherwise move the puck or ball. A periphery 50 of the blade 14 comprises a front surface 52 and a rear surface 54 opposite one another, as well as a top edge 56, a toe edge 58, a heel edge 59, and a bottom edge 60. The blade 14 comprises a toe region 61, a heel region 62, and an intermediate region 63 between the toe region 61 and the heel region 62. The blade 14 has a longitudinal direction that defines a length of the blade 14, a thicknesswise direction that is normal to the longitudinal direction and defines a thickness of the blade 14, and a heightwise direction that is normal to the longitudinal direction and defines a height of the blade 14.

A cross-section of the blade 14 may have any suitable configuration. For instance, in this embodiment, the cross-section of the blade 14 varies along the longitudinal direction of the blade 14 (e.g., tapers towards the toe region 61 of the blade 14), with the front surface 52 and the rear surface 54 curving so that the front surface 52 is concave and the rear surface 54 is convex. Corners between the front surface 52, the rear surface 54, the top edge 56, the toe edge 58, the heel edge 59, and the bottom edge 60 may be rounded or beveled.

The blade 14 may have any other suitable shape and/or be constructed in any other suitable way in other embodiments. For example, in some embodiments, the cross-section of the blade 14 may have any other suitable shape (e.g., the front surface 52, the rear surface 54, the top edge 56, the toe edge 58, the heel edge 59, and the bottom edge 60 may be curved differently and/or angular and/or have any other suitable shape, etc.).

The shaft 12 and the blade 14 may be interconnected in any suitable way. For instance, in this embodiment, the shaft 12 and the blade 14 are integrally formed with one another (i.e., at least part of the shaft 12 and at least of the blade 14 are integrally formed together) such that they constitute a one-piece stick. In other embodiments, the blade 14 may be secured to and removable from the shaft 12 (e.g., by inserting a shank of the blade 14, which may include a tenon, into a cavity of the shaft 12).

In this embodiment, the hockey stick 10 includes an open structure 68 and a covering 69 that covers at least part of the open structure 68. This may reduce a weight of the hockey stick 10, enhance properties such as the strength, the stiffness, the flex, the impact resistance, and/or other characteristics of the hockey stick 10, etc.

More particularly, in this embodiment, at least part of the hockey stick 10 is latticed, i.e., comprises a lattice 70. Thus, in this example, the lattice 70 constitutes at least part of the shaft 12 and/or at least part of the blade 14. Specifically, in this example, the shaft 12 includes a portion 71 of the lattice 70, while the blade 14 includes another portion 73 of the lattice 70. In this embodiment, the lattice 70 occupies at least a majority (i.e., a majority or an entirety) of the length of the shaft 12 and at least a majority (i.e., a majority or an entirety) of the length of the blade 14.

In some embodiments, the lattice 70 comprises a framework of structural members 41₁-41_{E} that intersect one another. In some embodiments, the structural members 41₁-41_{E} may be arranged in a regular arrangement repeating over the lattice 70. In some cases, the lattice 70 may be viewed as made up of unit cells 37₁-37_{C} each including a subset of the structural members 41₁-41_{E} that forms the regular arrangement repeating over the lattice 70. Each of these unit cells 37₁-37_{C} can be viewed as having a voxel, which refers to a notional three-dimensional space that it occupies. In other embodiments, the structural members 41₁-41_{E} may be arranged in different arrangements over the lattice 70 (e.g., which do not necessarily repeat over the lattice 70, do not necessarily define unit cells, etc.).

The lattice 70, including its structural members 41₁-41_{E}, may be configured in any suitable way.

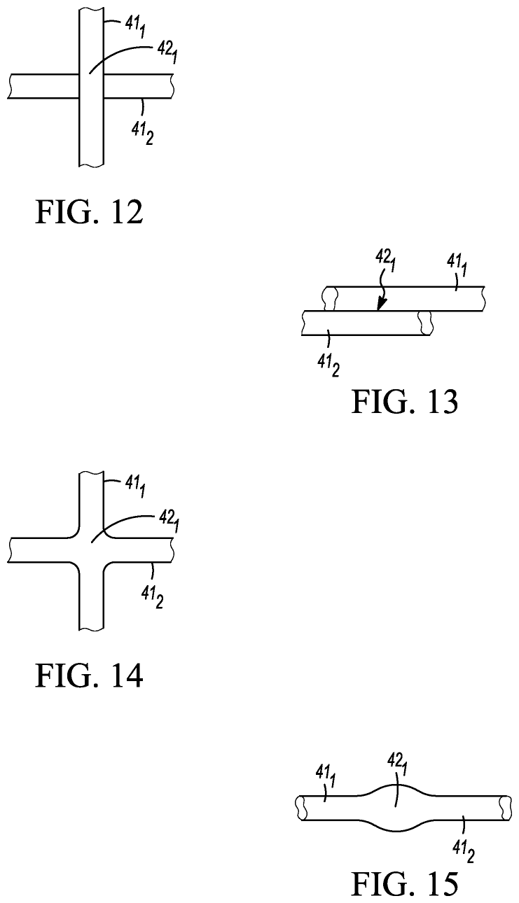

In this embodiment, the structural members 41₁-41_{E} are elongate members that intersect one another at nodes 42₁-42_{N}. The elongate members 41₁-41_{E} may sometimes be referred to as “beams” or “struts”. Each of the elongate members 41₁-41_{E} may be straight, curved, or partly straight and partly curved. While in some embodiments at least some of the nodes 42₁-42_{N} (i.e. some of the nodes 42₁-42_{N} or every one of the nodes 42₁-42_{N}) may be formed by having the structural members 41₁-41_{E} forming the nodes affixed to one another (e.g., chemically fastened, via an adhesive, etc.), as shown in FIGS. 12 and 13, in some embodiments at least some of the nodes 42₁-42_{N} (i.e. some of the nodes 42₁-42_{N} or every one of the nodes 42₁-42_{N}) may be formed by having the structural members 41₁-41_{E} being unitary (e.g., integrally made with one another, fused to one another, etc.), as shown in FIGS. 14 and 15. Also, in this embodiment, the nodes 42₁-42_{N} may be thicker than respective ones of the elongate members 41₁-41_{E} that intersect one another thereat, as shown in FIGS. 13 and 15, while in other embodiments the nodes 42₁-42_{N} may have a same thickness as respective ones of the elongate members 41₁-41_{E} that intersect one another thereat.

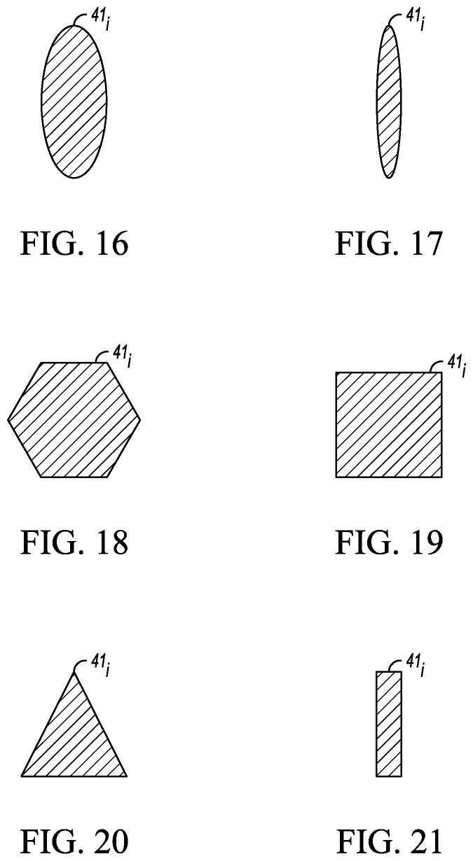

In this embodiment, the structural members 41₁-41_{E} may have any suitable shape, as shown in FIGS. 16 to 21. That is, a cross-section of a structural member 41ᵢ across a longitudinal axis of the structural member 41₁ may have any suitable shape, for instance: a circular shape, an oblong shape, an elliptical shape, a square shape, a rectangular shape, a polygonal shape (e.g. triangle, hexagon, and so on), etc.

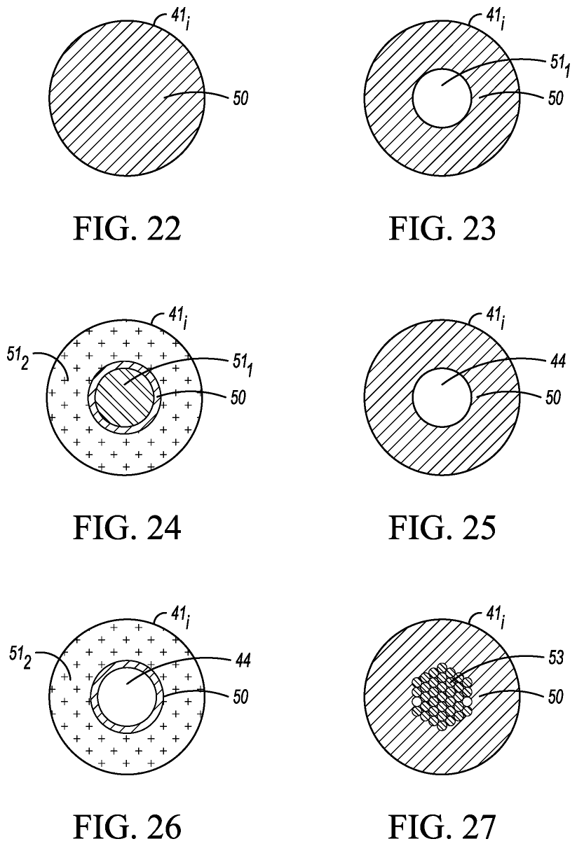

Moreover, in this embodiment, the structural member 41ᵢ may comprise any suitable structure and any suitable composition, as shown in FIGS. 22 to 27. As an example, the structural member 41ᵢ may be solid (i.e. without any void) and composed of a material 50, as shown in FIG. 22. In another embodiment, the structural member 41ᵢ may comprise the material 50 and another material 51₁ inner to the material 50, as shown in FIG. 23. In another embodiment, the structural member 41ᵢ may comprise the material 50, the other material 51₁ inner to the material 50 and another material 51₂ outer to the material 50, as shown in FIG. 24. In another embodiment, the structural member 41ᵢ may be composed of the material 50 and may comprise a void 44 that is not filled by any specific solid material, as shown in FIG. 25. In another embodiment, the structural member 41ᵢ may comprise the material 50, another material outer to the material 50 and the void 44 that is not filled by any specific solid material, as shown in FIG. 26. In another embodiment, the structural member 41ᵢ may comprise the material 50 and a plurality of reinforcements 53 (e.g. continuous or chopped fibers), as shown in FIG. 27.

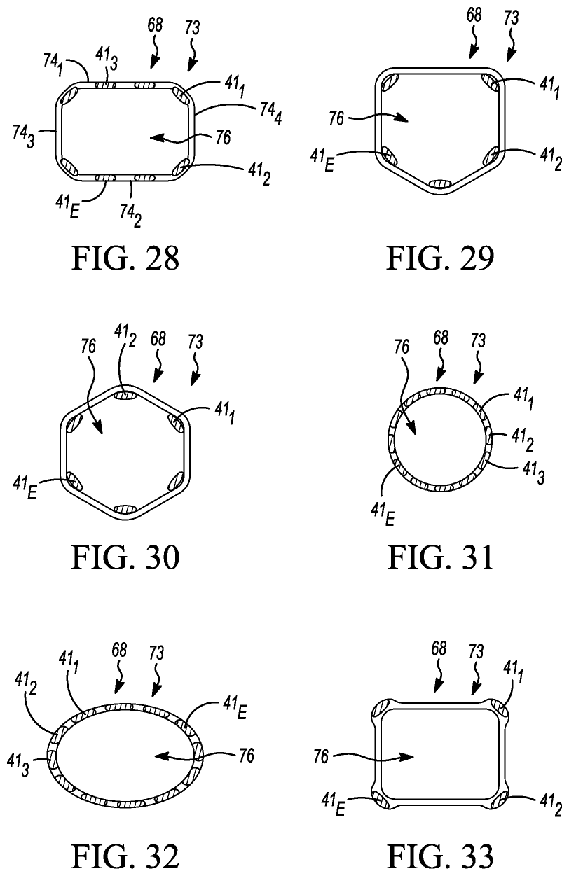

More particularly, in this embodiment, the lattice 70 includes a truss 73, as shown in FIG. 28. In this example, the truss 73 constitutes the portion 71 of the lattice 70 of the shaft 12. The truss 73 comprises peripheral portions 74₁-74₄ that are part of walls 75₁-75₄ of the shaft 12 that define the periphery 30 of the shaft 12, including its front surface 16, rear surface 18, top surface 22 and bottom surface 24. Each of the peripheral portions 74₁-74₄ of the truss 73 includes respective ones of the elongate members 41₁-41_{E} and the nodes 42₁-42_{N} of the lattice 70. A front one of the peripheral portions 74₁-74₄ of the truss 73 is part of a front one of the walls 75₁-75₄ of the shaft 12 that includes its front surface 16, a rear one of the peripheral portions 74₁-74₄ of the truss 73 is part of a rear one of the walls 75₁-75₄ of the shaft 12 that includes its rear surface 18, a top one of the peripheral portions 74₁-74₄ of the truss 73 is part of a top one of the walls 75₁-75₄ of the shaft 12 that includes its top surface 22, and a bottom one of the peripheral portions 74₁-74₄ of the truss 73 is part of a bottom one of the walls 75₁-75₄ of the shaft 12 that includes its bottom surface 24.

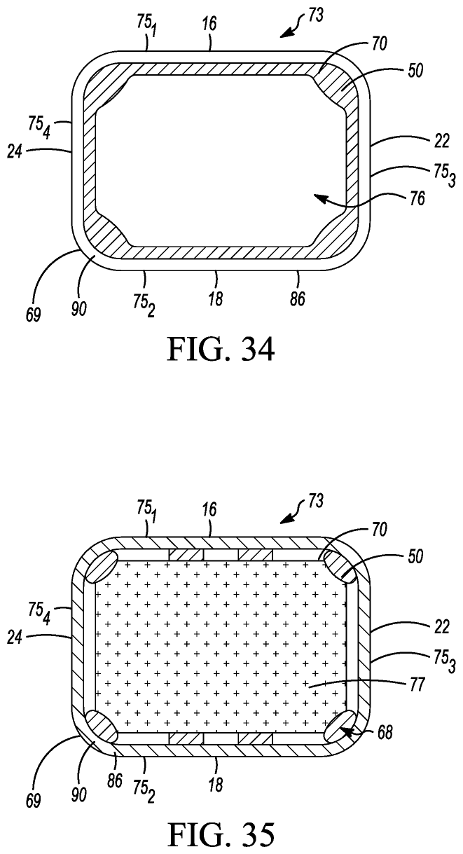

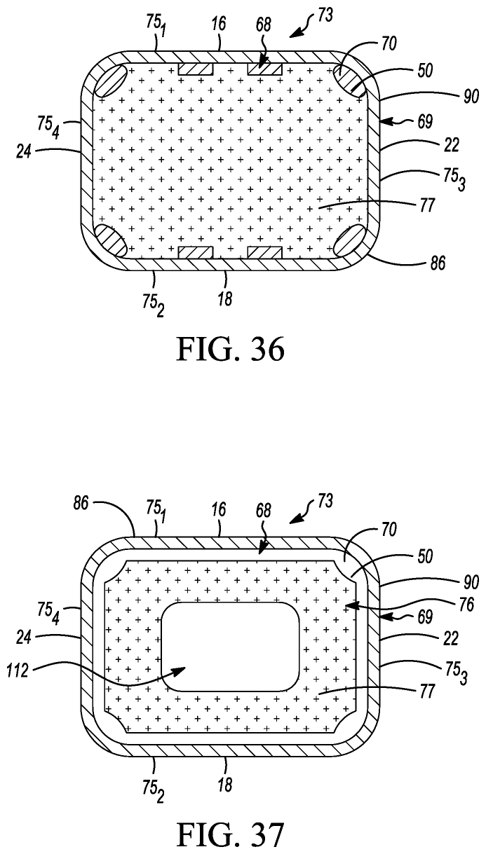

In this example, between its peripheral portions 74₁-74₄, the truss 73 includes a void 76, as shown in FIG. 34. In this embodiment, the shaft 12 comprises a core 77 disposed in the void 76 of the truss 73, as shown in FIGS. 35 and 36. The core 77 may be entirely disposed inside the lattice 70 such that it does not engage a surface of the covering 69, as shown in FIG. 35, although alternatively the core 77 may engage the lattice 70 and the inner surface of the covering 69, in the embodiment shown in FIG. 36. For instance, the core 77 may include one or more internal members of foam, elastomeric material, etc. Alternatively, in other embodiments, the void 76 of the truss 73 may be hollow (i.e., not contain any core), or may be filled by the core 77 having a shape defining an inner void 112.

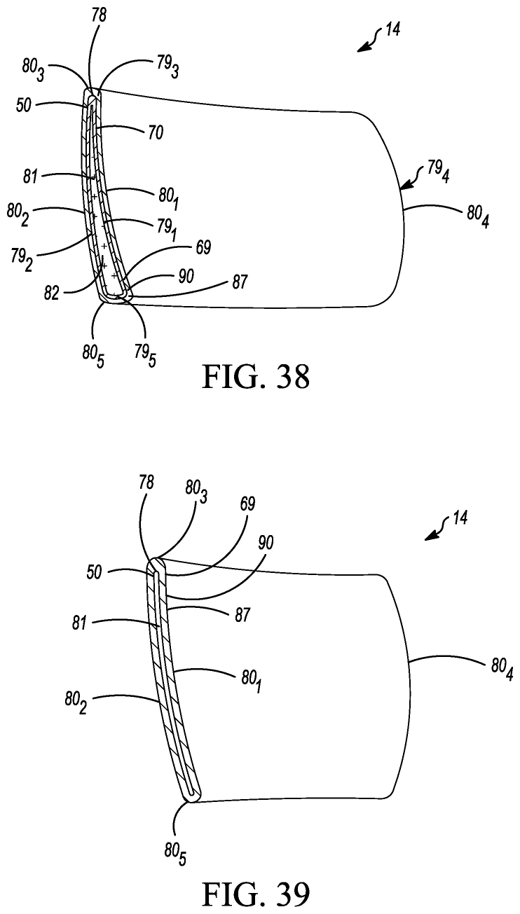

Also, in this embodiment, the lattice 70 includes another truss 78, as shown in FIGS. 38 and 39. In this example, the truss 78 constitutes the portion 73 of the lattice 70 of the blade 14. The truss 78 comprises peripheral portions 79₁-79₆ that are part of walls 80₁-80₆ of the blade 14 that define the periphery 50 of the blade 14, including its front surface 52, rear surface 54, top edge 56, toe edge 58, heel edge 59, and bottom edge 60. Each of the peripheral portions 79₁-79₆ of the truss 78 includes respective ones of the elongate members 41₁-41_{E} and the nodes 42₁-42_{N} of the lattice 70. A front one of the peripheral portions 79₁-79₆ of the truss 78 is part of a front one of the walls 80₁-80₆ of the blade 14 that includes its front surface 52, a rear one of the peripheral portions 79₁-79₆ of the truss 78 is part of a rear one of the walls 80₁-80₆ of the blade 14 that includes its rear surface 54, a top one of the peripheral portions 79₁-79₆ of the truss 78 is part of a top one of the walls 80₁-80₆ of the blade 14 that includes its top edge 56, a toe one of the peripheral portions 79₁-79₆ of the truss 78 is part of a toe one of the walls 80₁-80₆ of the blade 14 that includes its toe edge 48, a heel one of the peripheral portions 79₁-79₆ of the truss 78 is part of a heel one of the walls 80₁-80₆ of the blade 14 that includes its heel edge 59, and a bottom one of the peripheral portions 79₁-79₆ of the truss 78 is part of a bottom one of the walls 80₁-80₆ of the blade 14 that includes its bottom edge 60.

In this example, between its peripheral portions 79₁-79₆, the truss 78 includes a void 81. In this embodiment, the blade 14 comprises a core 82 disposed in the void 81 of the truss 78. For instance, the core 82 may include one or more internal members of foam, elastomeric material, etc. Alternatively, in other embodiments, the void 81 of the truss 78 may be hollow (i.e., not contain any core).

Material 50 of the lattice 70 can be of any suitable kind. In this embodiment, the material 50 is composite material. More particularly, in this embodiment, the composite material 50 is fiber-reinforced composite material comprising fibers disposed in a matrix. For instance, in some embodiments, the material 50 may be fiber-reinforced plastic (FRP—a.k.a., fiber-reinforced polymer), comprising a polymeric matrix may include any suitable polymeric resin, such as a thermoplastic or thermosetting resin, like epoxy, polyethylene, polypropylene, acrylic, thermoplastic polyurethane (TPU), polyether ether ketone (PEEK) or other polyaryletherketone (PAEK), polyethylene terephthalate (PET), polyvinyl chloride (PVC), poly(methyl methacrylate) (PMMA), polycarbonate, acrylonitrile butadiene styrene (ABS), nylon, polyimide, polysulfone, polyimide-imide, self-reinforcing polyphenylene, polyester, vinyl ester, vinyl ether, polyurethane, cyanate ester, phenolic resin, etc., a hybrid thermosetting-thermoplastic resin, or any other suitable resin, and fibers such as carbon fibers, glass fibers, polymeric fibers such as aramid fibers (e.g., Kevlar fibers), boron fibers, silicon carbide fibers, metallic fibers, ceramic fibers, etc. In some embodiments, the fibers of the fiber-reinforced composite material 50 may be provided as layers of continuous fibers, such as pre-preg (i.e., pre-impregnated) tapes of fibers (e.g., including an amount of resin) or as continuous fibers deposited (e.g., printed) along with rapidly-curing resin forming the polymeric matrix. In other embodiments, the fibers of the fiber-reinforced composite material 50 may be provided as fragmented (e.g., chopped) fibers dispersed in the polymeric matrix.

In some embodiments, the material 50 of the lattice 70 may be identical throughout the lattice 70. In other embodiments, the material 50 of the lattice 70 may be different in different parts of the lattice 70. For example, in some embodiments, the material 50 of the portion 71 of the lattice 70 that is part of the shaft 12 may be different from the material 50 of the portion 73 of the lattice 70 that is part of the blade 14. Alternatively or additionally, in some embodiments, the material 50 of one region of the portion 71 of the lattice 70 that is part of the shaft 12 may be different from the material 50 of another region of the portion 71 of the lattice 70 that is part of the shaft 12, and/or the material 50 of one region of the portion 73 of the lattice 70 that is part of the blade 14 may be different from the material 50 of another region of the portion 73 of the lattice 70 that is part of the blade 14.

The material 50 of the lattice 70 may be polymeric material (e.g., not fiber-reinforced), metallic material, or ceramic material in other embodiments.

The lattice 70 of the hockey stick 10 may be designed to have properties of interest in various embodiments.

For example, in some embodiments, strength of the lattice 70 may be at least 800N, in some cases at least 1000N, some cases at least 1100N, some cases at least 1200N, and in some cases at least 1300N, and/or in some cases no more than 2000N, in some cases no more than 1500N, in some cases no more than 1400N, in some cases no more than 1300N, in some cases no more than 1200N, in some cases no more than 1100N, in some cases no more than 1000N, in some cases even less.

The strength of the lattice 70 may be measured by a 3-points-bending test to failure, as shown in FIG. 61. In this example, the supports used for the 3-points-bending test to failure may be spaced from one another by a distance of approximately 1050 mm, while the strength corresponds to the force applied at the midpoint between the supports.

In some embodiments, the lattice 70 may include distinct zones 92₁-92_{Z} that are structurally different from one another. For instance, this may be useful to modulate properties, such as the strength, flex, stiffness, etc., of the zones 92₁-92_{Z} of the lattice 70.

For example, the zones 92₁-92_{Z} of the lattice 70 may include a zone 92ᵢ at the proximal end portion 26 of the shaft 12, a zone 922 at the distal end portion 28 of the shaft 12, a zone 923 at the toe region 61 of the blade 14, a zone 924 at the heel region 62 of the blade 14, and a zone 925 at the intermediate region 63 of the blade 14.

In this embodiment, delimitations of the zones 92₁-92_{Z} of the lattice 70 are configured to match different parts of the hockey stick 10 which may be subject to different stresses and may require different mechanical properties. Accordingly, the zones 92₁-92_{Z} of the lattice 70 may have different mechanical properties to facilitate puck handling, to increase power transmission and/or energy transmission from the hockey stick 10 to the puck during wrist shots and/or slap shots, to lighten the hockey stick, to increase impact resistance of the hockey stick 10, to increase elongation at break of the hockey stick 10, to position a kickpoint, to reduce manufacturing costs, and so on.

Mechanical properties of the zones 92₁-92_{Z} of the lattice 70 may be achieved by any suitable means.

For example, in some embodiments, a shape of the unit cells 37₁-37_{C} of each zone 92ᵢ may be pre-determined to increase or diminished the aforementioned mechanical properties.

As another example, in some embodiments, the voxel (or size) of the unit cells 37₁-37_{C} of each zone 92ᵢ may be pre-determined to increase or diminished the aforementioned mechanical properties.

As another example, in some embodiments, a thickness of elongate members 41₁-41_{E} of each zone 92ᵢ may be pre-determined to increase or diminished the aforementioned mechanical properties..

As another example, in some embodiments, the material 50 of each zone 92ᵢ may be pre-determined to increase or diminished the aforementioned mechanical properties.

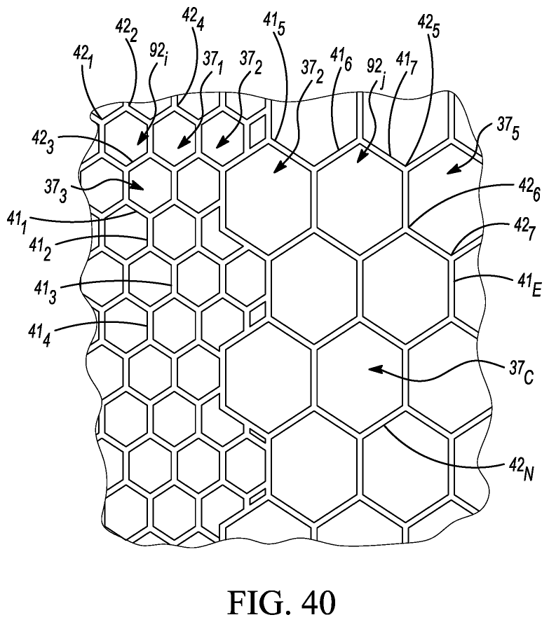

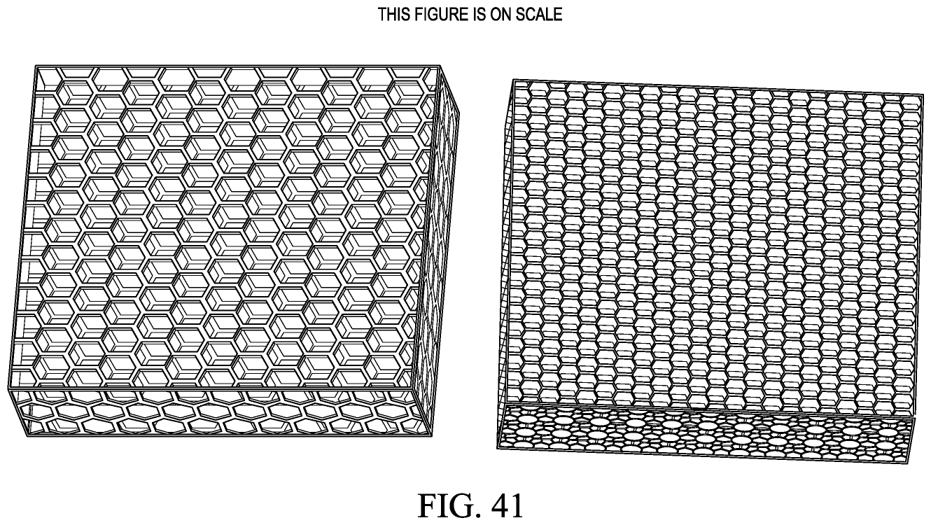

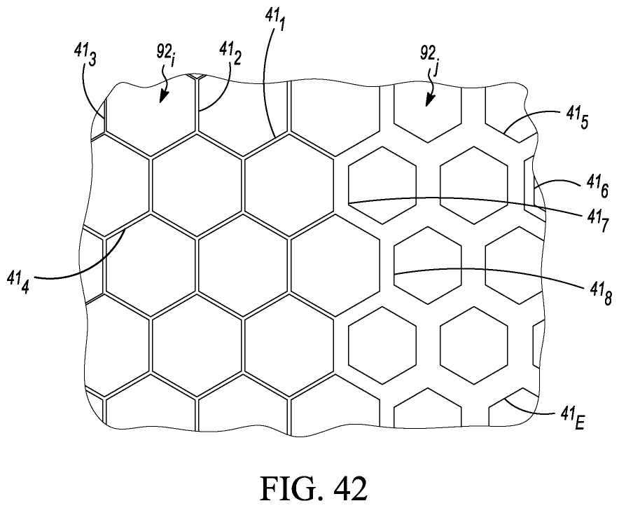

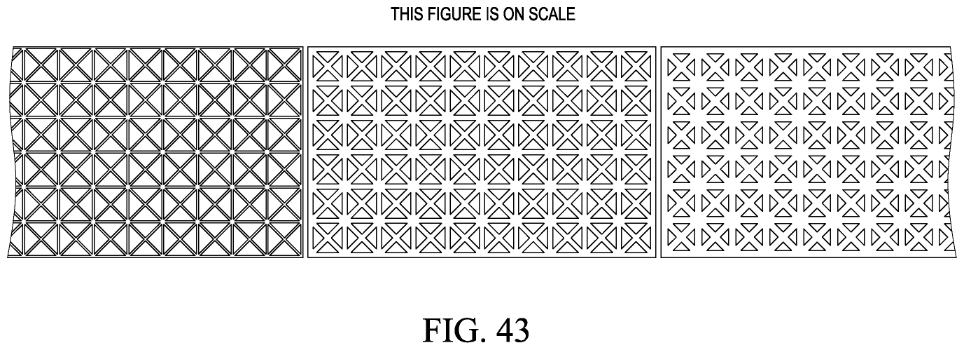

As such, in some embodiments, the shape of the unit cells 37₁-37_{C} (and thus the shape of the elongate members 41₁-41_{E} and/or nodes 42₁-42_{N}), the voxel (or size) of the unit cells 37₁-37_{C}, a thickness of elongate members 41₁-41_{E} of each zone 921 and/or the material 50 of each zone 92ᵢ may vary between the zones 92₁-92_{Z}. For instance, in some embodiments, adjacent ones of the nodes 42₁-42_{N} in one region 92ᵢ of the lattice 70 may be located closer to one another than adjacent ones of the nodes 42₁-42_{N} in another region of the lattice 70, as shown in FIGS. 40 and 41, and/or the thickness of the elongate members 41₁-41_{E} and nodes 42₁-42_{N} in one region 92ᵢ of the lattice 70 may be greater than the thickness of the elongate members 41₁-41_{E} and nodes 42₁-42_{N} in another region 92ⱼ of the lattice 70, as shown in FIGS. 42 and 43 .

In this embodiment, the distinct zones 92₁-92_{Z} of the lattice 70 differ in stiffness and/or stiffness. For example, in some embodiments, a ratio of the stiffness of a given one of the zones 92₁-92_{Z} of the lattice 70 over the stiffness of another one of the zones 92₁-92_{Z} of the lattice 70 may be at least 10%, in some embodiments at least 20%, in some embodiments at least 30%, in some embodiments at least 40%, in some embodiments even more. Similarly, in some embodiments, a ratio of the strength of a given one of the zones 92₁-92_{Z} of the lattice 70 over the strength of another one of the zones 92₁-92_{Z} of the lattice 70 may be at least 10%, in some embodiments at least 20%, in some embodiments at least 30%, in some embodiments at least 40%, in some embodiments even more.

In this embodiment, the distinct zones 92₁-92_{Z} of the lattice 70 differ in resilience.

For example, in some embodiments, a ratio of the resilience of a given one of the zones 92₁-92_{Z} of the lattice 70 over the resilience of another one of the zones 92₁-92_{Z} of the lattice 70 may be at least 5%, in some embodiments at least 10%, in some embodiments at least 20%, in some embodiments at least 30%, in some embodiments even more.

In this embodiment, the covering 69 may covers at least part of the open structure 68 of the hockey stick 10. In that sense, the covering 69 may be viewed as a “skin”. In this embodiment, the covering 69 covers at least a majority (i.e., a majority or an entirety) of the lattice 70. More particularly, in this embodiment, the covering 69 covers the entirety of the lattice 70, as notably shown in FIG. 6. The hockey stick 10 may thus externally appear like a conventional hockey stick, as its open structure 68 is concealed.

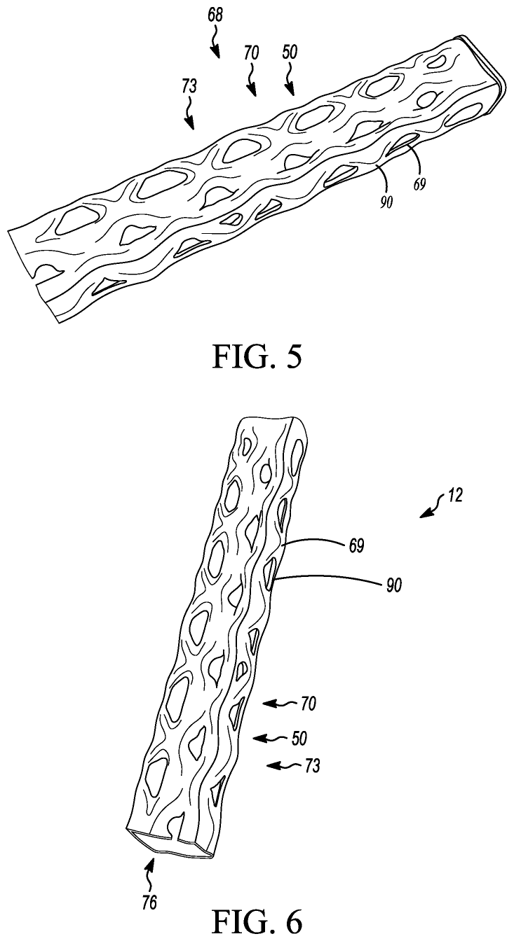

In other embodiments, the covering 69 may not cover the entirety of the lattice open structure 68 and may therefore comprise apertures, as shown in FIG. 5.

In this embodiment, the shaft 12 includes a portion 86 of the covering 69, while the blade 14 includes another portion 87 of the covering 69. The portion 86 of the covering 69 thus covers the truss 73 of the shaft 12, whereas the portion 87 of the covering 69 covers the truss 78 of the blade 14.

Material 90 of the covering 69 can be of any suitable kind. In this embodiment, the material 90 is composite material. More particularly, in this embodiment, the composite material 90 is fiber-reinforced composite material comprising fibers disposed in a matrix. For instance, in some embodiments, the material 90 may be fiber-reinforced plastic (FRP—a.k.a., fiber-reinforced polymer), comprising a polymeric matrix may include any suitable polymeric resin, such as a thermoplastic or thermosetting resin, like epoxy, polyethylene, polypropylene, acrylic, thermoplastic polyurethane (TPU), polyether ether ketone (PEEK) or other polyaryletherketone (PAEK), polyethylene terephthalate (PET), polyvinyl chloride (PVC), poly(methyl methacrylate) (PMMA), polycarbonate, acrylonitrile butadiene styrene (ABS), nylon, polyimide, polysulfone, polyimide-imide, self-reinforcing polyphenylene, polyester, vinyl ester, vinyl ether, polyurethane, cyanate ester, phenolic resin, etc., a hybrid thermosetting-thermoplastic resin, or any other suitable resin, and fibers such as carbon fibers, glass fibers, polymeric fibers such as aramid fibers (e.g., Kevlar fibers), boron fibers, silicon carbide fibers, metallic fibers, ceramic fibers, etc. In some embodiments, the fibers of the fiber-reinforced composite material 50 may be provided as layers of continuous fibers, such as pre-preg (i.e., pre-impregnated) tapes of fibers (e.g., including an amount of resin) or as continuous fibers deposited (e.g., printed) along with rapidly-curing resin forming the polymeric matrix. In other embodiments, the fibers of the fiber-reinforced composite material 90 may be provided as fragmented (e.g., chopped) fibers dispersed in the polymeric matrix.

In some embodiments, the material 90 of the covering 69 may be identical throughout the covering 69. In other embodiments, the material 90 of the covering 69 may be different in different parts of the covering 69. For example, in some embodiments, the material 90 of the portion 86 of the covering 69 that is part of the shaft 12 may be different from the material 90 of the portion 87 of the covering 69 that is part of the blade 14. Alternatively or additionally, in some embodiments, the material 90 of one region of the portion 86 of the covering 69 that is part of the shaft 12 may be different from the material 90 of another region of the portion 86 of the covering 69 that is part of the shaft 12, and/or the material 90 of one region of the portion 87 of the covering 69 that is part of the blade 14 may be different from the material 90 of another region of the portion 87 of the covering 69 that is part of the blade 14.

In other embodiments, the material 90 of the covering 69 may be (non-fiber-reinforced) polymeric material, metallic material, or ceramic material.

The hockey stick 10, including the lattice 70 and the covering 69, may be manufactured in any suitable way.

For example, in some embodiments, the lattice 70 may be an additively-manufactured lattice that is additively manufactured, i.e., made by additive manufacturing, also known as 3D printing, in which the material 50 thereof initially provided as feedstock (e.g., as powder, liquid, filaments, fibers, and/or other suitable feedstock), which can be referred to as 3D-printed material, is added by a machine (i.e., a 3D printer) that is computer-controlled (e.g., using a digital 3D model such as a computer-aided design (CAD) file) to create it in its three-dimensional form (e.g., layer by layer, from a pool of liquid, applying continuous fibers, or in any other way, normally moldlessly, i.e., without any mold). This is in contrast to subtractive manufacturing (e.g., machining) where material is removed and molding where material is introduced into a mold's cavity.

Any 3D-printing technology may be used to make the lattice 70. For instance, in some embodiments, fused deposition modeling (FDM), digital light processing (DLP), stereolithography (SLA), selective laser sintering (SLS), material jetting (MJ), binder jetting (BJ), continuous-fiber 3D printing, and/or any other suitable 3D-printing technology may be used. Examples of suitable 3D-printing technologies may include those available from Carbon (www.carbon3d.com), EOS (https://www.eos.info/en), HP, (https://www8.hp.com/ca/en/printers/3d-printers. html), Arevo (https://arevo.com), and Continuous Composites (https://www.continuouscomposites.com/).

In this embodiment, as it includes the fiber-reinforced composite material 50, the lattice 70 may be 3D-printed using continuous-fiber 3D printing technology. For instance, in some embodiments, this may allow each of one or more of the fibers of the fiber-reinforced composite material 50 to extend along at least a significant part, such as at least a majority (i.e., a majority or an entirety), of a length of the lattice 70 (e.g., monofilament winding). This may enhance the strength, the impact resistance, and/or other properties of the hockey stick 10.

The lattice 70 can be designed and 3D-printed to impart its properties and functions, such as those discussed above, while helping to minimize its weight. The 3D-printed material 50 constitutes the lattice 70. Specifically, the elongate members 41₁-41_{E} and the nodes 42₁-42_{N} of the lattice 70 include respective parts of the 3D-printed material 50 that are created by the 3D-printer. Fibers may be printed by the 3D printer along with rapidly-curing resin to form the fiber-reinforced composite material 50.

The lattice 70 may be manufactured in any other suitable way in other embodiments, including by technology other than 3D printing.

For instance, in some embodiments, the lattice 70 may be provided by positioning pre-preg tapes of fibers (e.g., including an amount of resin) to form the elongate members 41₁-41_{E} and the nodes 42₁-42_{N} of the lattice 70 and heating it (e.g., in a mold) to form its fiber-reinforced composite material 50 once cured.

For instance, pre-preg tapes of fibers may be enrolled around a support 108 (e.g. a mandrel, foam, procured part, and so on) with a pre-determined pitch and a pre-determined angle to form a “green” lattice. The pre-determined pitch and pre-determined angle used to form the green lattice may contribute to determine the geometry of the unit cells 37₁-37_{C} and thus mechanical properties (e.g. stiffness) of the lattice 70.

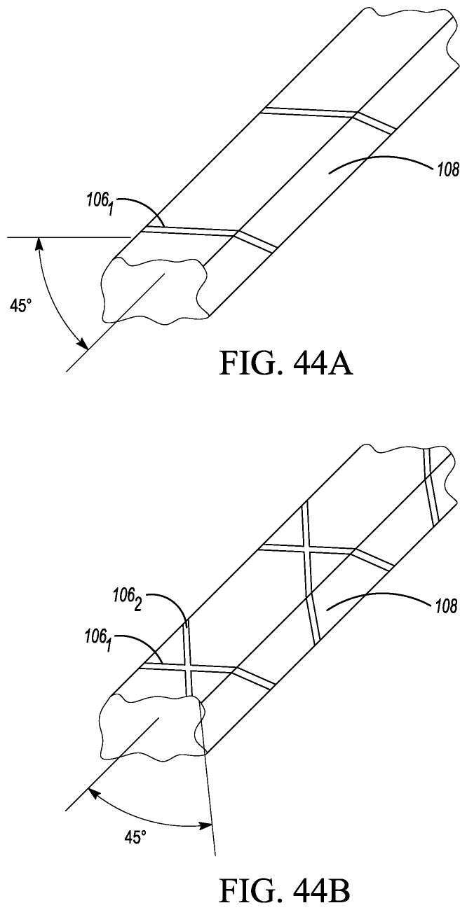

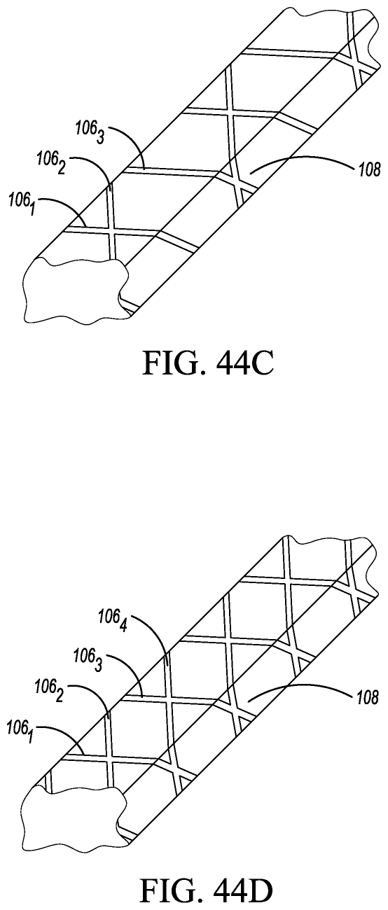

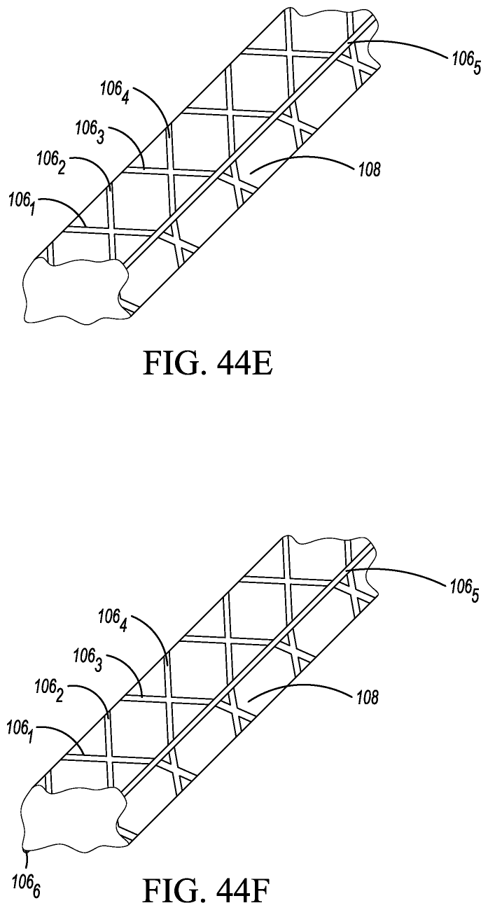

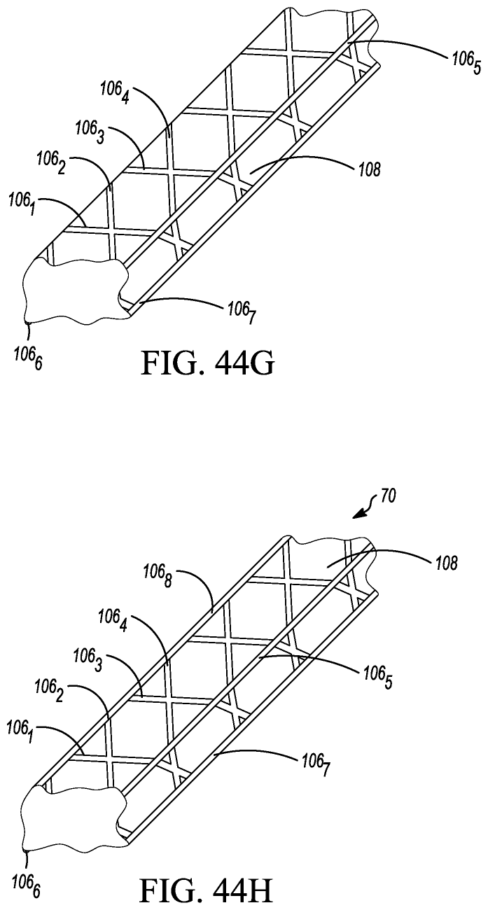

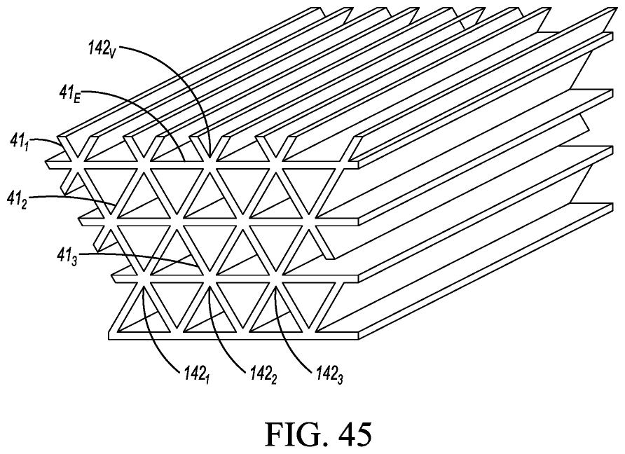

For example, in some embodiments, as shown in FIGS. 44A to 44H, the lattice 70 may comprise segments 1061-106₈ each formed using one continuous string of pre-preg tape and the structural members 41₁-41_{E} may have a thickness of 1 mm. In order to form the lattice 70, the pre-preg tape may have a thickness of 1 mm and be enrolled successively around the support 108, at a pre-determined angle. For example, segments 106₅-106₈ forming edges (i.e. corners) of the lattice 70 may be enrolled at an angle of 0° relative to a longitudinal axis of the support, while segments 106₁, 106₃ may be enrolled at an angle of about 45° relative to a longitudinal axis of the support and segments 106₂, 106₄ may be enrolled at an angle of about −45° relative to a longitudinal axis of the support. Each time segments 106₁-106₈ cross one another, a node 421 may be created—each node 421 having a thickness that is superior to the thickness of the segments 106₁-106₈ in this embodiment.

As another example, in some embodiments, to obtain a similar lattice 70 using pre-preg tape having a thickness of 0.25 mm, four successive passes of the aforementioned steps may be repeated, which in comparison with the preceding embodiment may provide a lattice 70 having superior strength and interlaminar shear.

It is noted that, in other embodiments, width, thickness and material of the pre-preg tape used for manufacturing the lattice 70 may vary for each segment 106ᵢ and/or for each pass, and that any stage layers of material (e.g. the covering 69) may be added under or over the .

The obtained “green” 70 may be subsequently cured or molded, for example using an autoclave, vacuum molding, RTM, compression molding (e.g. with a bladder or a mandrel to control an external dimension of the lattice during and after molding), or so on.

The covering 69 may be provided about the lattice 70 in any suitable way in various embodiments.

For example, in some embodiments, the covering 69 may be an additively-manufactured covering that is additively manufactured, i.e., 3D-printed. Any 3D-printing technology may be used to make the covering 69, such as those discussed above. For instance, in some embodiments, the covering 69 may be 3D-printed using continuous-fiber 3D printing technology. This may allow each of one or more of the fibers of the fiber-reinforced composite material 90 to extend along at least a significant part, such as at least a majority (i.e., a majority or an entirety), of a length of the covering 69 (e.g., monofilament winding).

As another example, in some embodiments, the covering 69 may be provided by wrapping pre-preg tapes of fibers (e.g., including an amount of resin) about the lattice 70 and heating it (e.g., in a mold) to form its fiber-reinforced composite material 90 once cured.

The hockey stick 10, including the shaft 12 and the blade 14, may be implemented in various other ways in other embodiments.

For example, in some embodiments, the lattice 70 may have any suitable cross-section shape such as a pentagonal shape, a hexagonal shape, a round shape, an elliptical shape, and so on, as shown in FIGS. 29 to 34. Additionally, the shape of the cross-section of the lattice 70 may vary from a zone 92i to another 92ⱼ.

In this embodiment, the portion 73 of the lattice 70 that is part of the blade 14 may be structurally different from the portion 71 of the lattice 70 that is part of the shaft 12. For example, an average voxel of the unit cells 37₁-37_{C} of the portion 73 of the lattice 70 may be significantly smaller than an average voxel of the unit cells 37₁-37_{C} of the portion 71 of the lattice 70 and in some embodiments a ratio of the average voxel of the portion 73 over the average voxel of the portion 71 may be less than 0.95, in some embodiments less than 0.75, in some embodiments less than 0.50, in some embodiments less than 0.25, in some embodiments even less. As another example, the shape of the unit cells 37₁-37_{C} of the portion 73 of the lattice 70 may be different from the shape of the unit cells 37₁-37_{C} of the portion 71 of the lattice 70 such that the portion 73 is significantly stiffer than the portion 71. As another example, in some embodiments, the portion 73 of the lattice 70 that is part of the blade 14 comprises a framework defining a non-hollow lattice, while the portion 71 of the lattice 70 that is part of the shaft 12 comprises a framework defining a hollow lattice.

As another example, in some embodiments, the structural members 41₁-41_{E} of the lattice 70 may be implemented in various other ways. For example, in some embodiments, as shown in FIG. 45, the structural members 41₁-41_{E} may be planar members that intersect one another at vertices 142₁-142_{V}. The planar members 41₁-41_{E} may sometimes be referred to as “faces”. Each of the planar members 41₁-41_{E} may be straight, curved, or partly straight and partly curved.

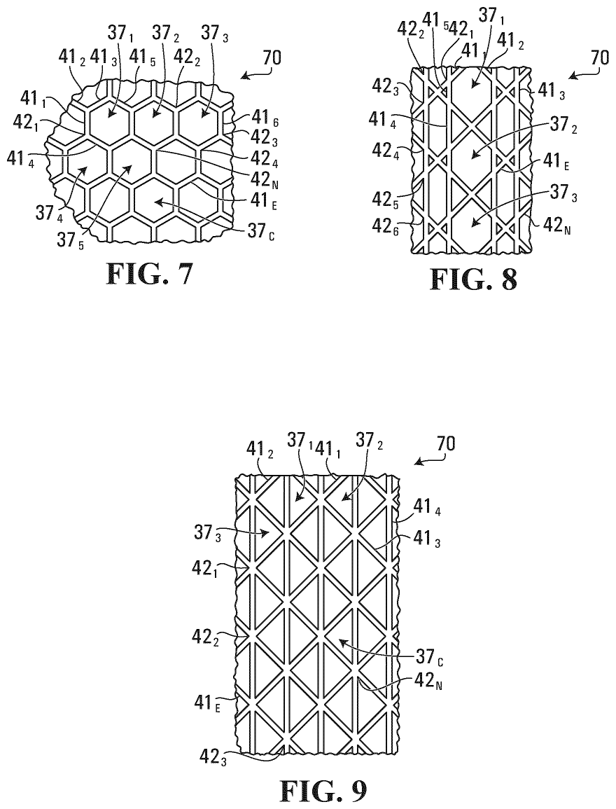

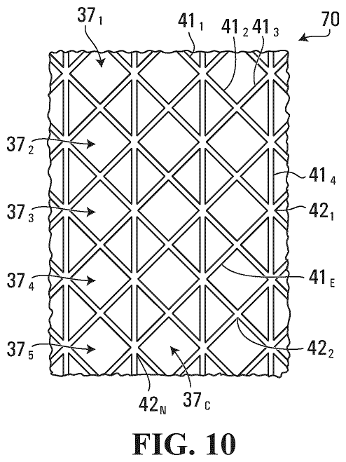

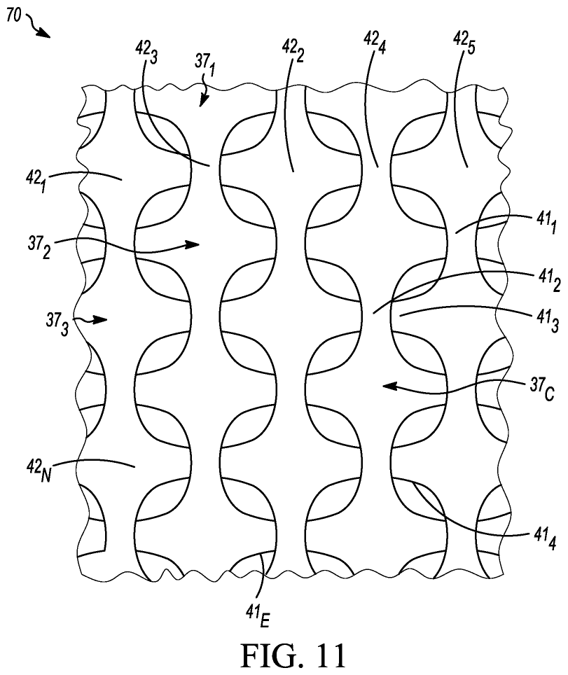

The lattice 70 may be implemented in any other suitable way and have any other suitable configuration. Examples of other possible configurations for the lattice 70 in other embodiments are shown in FIGS. 7 to 11.

In some embodiments, the hockey stick may be an “intelligent” hockey stick. That is, the hockey stick 10 may comprise sensors 280₁-280_{S} to sense a force acting on the hockey stick, a position, a speed, an acceleration and/or a deformation of the hockey stick 10 during play or during a testing (e.g. of hockey sticks, of players, etc.). More particularly, in this embodiment, the lattice 70 comprises the sensors 280₁-280_{S}. More specifically, in this embodiment, the sensors 280₁-280_{S} are associated with an additively-manufactured component of the lattice 70.

Further, in this embodiment, the hockey stick 10 may comprise actuators 286₁-286_{A}. Specifically, the actuators 286₁-286_{A} may be associated with at least some of sensors 280₁-280_{S} and may be configured to respond to a signal of the sensors 280₁-280_{S}. In particular, the sensors 280₁-280_{S} may be responsive to an event (e.g. an increase in acceleration of the hockey stick 10, an increase of a force acting on the hockey stick 10, an increase of the deformation of the hockey stick 10, etc.) to cause the actuators 286₁-286_{A} to alter the additively-manufactured component to alter the lattice 70 (e.g. to increase resilience, to increase stiffness, etc.).

Practically, in this embodiment, this may be achieved using piezoelectric material 290 implementing the sensors 280₁-280_{S}, the piezoelectric material 290 being comprised in the additively-manufactured component of the lattice 70.

In other embodiments, more or less of the hockey stick 10 may be latticed as discussed above.

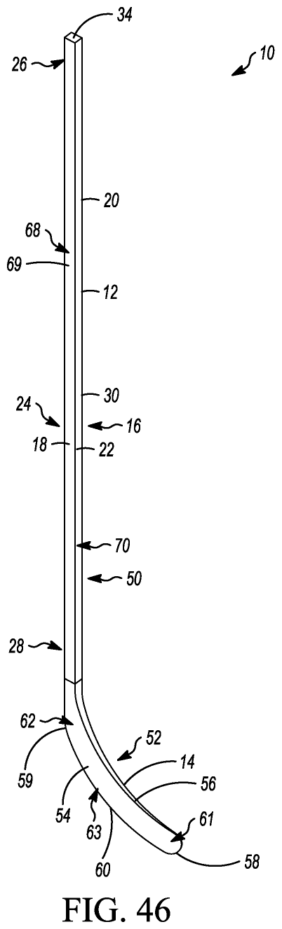

For example, in some embodiments, as shown in FIG. 46, the lattice 70 may constitute at least part (e.g., occupy at least a majority, i.e., a majority or an entirety, of the length) of the shaft 12, but not constitute any part of the blade 14. That is, the shaft 12 may include all of the lattice 70, while the blade 14 may not include any lattice.

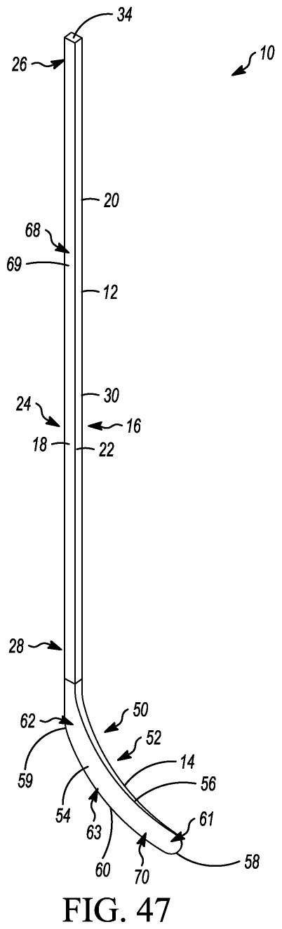

As another example, in some embodiments, as shown in FIG. 47, the lattice 70 may constitute at least part (e.g., occupy at least a majority, i.e., a majority or an entirety, of the length) of the blade 14, but not constitute any part of the shaft 12. That is, the blade 14 may include all of the lattice 70, while the shaft 12 may not include any lattice.

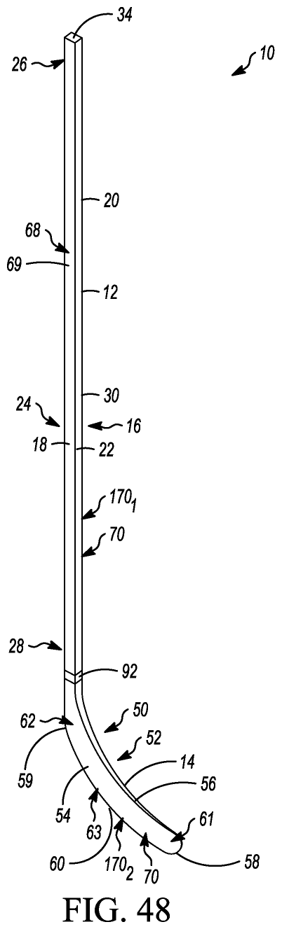

As yet another example, as shown in FIGS. 48, the shaft 12 and/or the blade 14 may include two or more lattices like the lattice 70 that are separate (e.g., spaced apart) from one another.

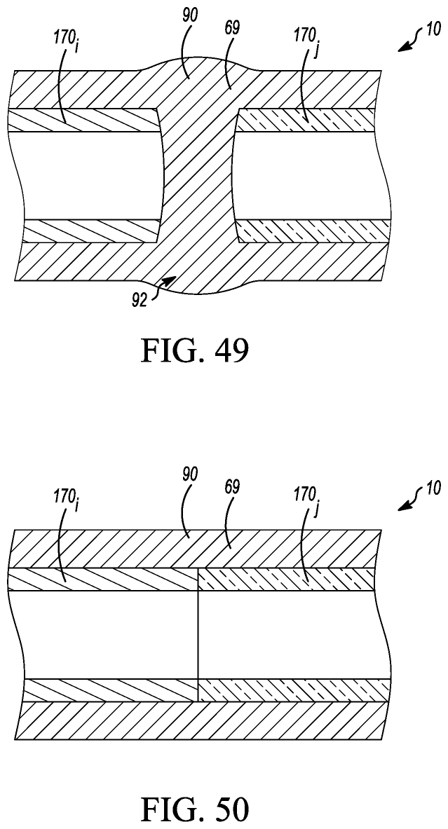

For instance, in some embodiments, as shown in FIGS. 48 and 49, the blade 14 may comprises lattices 170₁-170_{L} similar to the lattice 70 that are separate from one another. In this example, adjacent ones of the lattices 170₁-170_{L} are spaced from one another by a rib 92 extending from a front one of the walls 80₁-80₆ of the blade 14 to a back one of the walls 80₁-80₆ of the blade 14. The lattices 170₁-170_{L} may be or include distinct zones structurally different from one another, as discussed above. For example, in some embodiments, a lower one of the lattices 170₁-170_{L} may be less stiff or more resilient than a higher one of the lattices 170₁-170_{L} (e.g., to better absorb impacts).

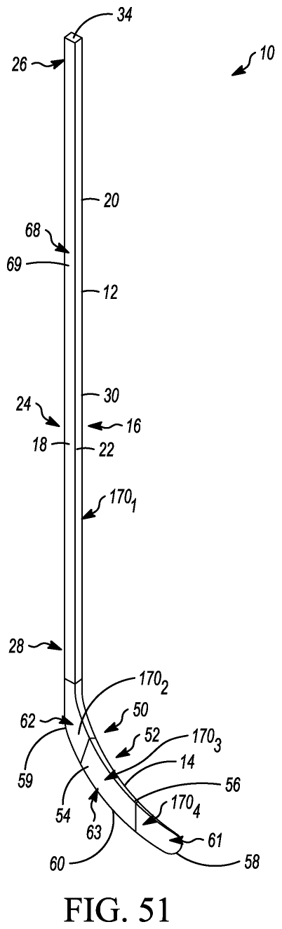

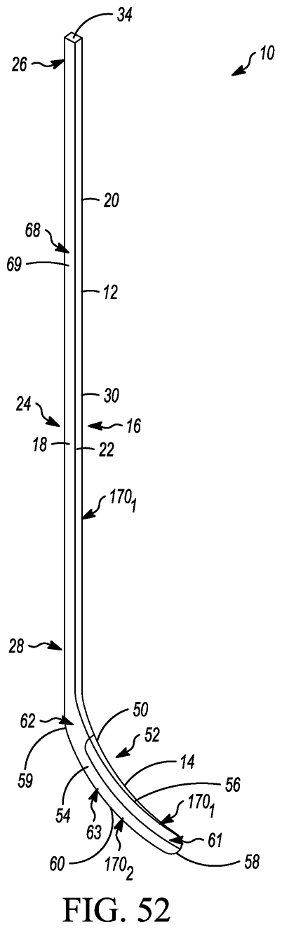

In some embodiments, as shown in FIG. 50, the lattices 170₁-170_{L} may not be spaced from one another by a rib 92 and may engage one another. For example, in some embodiments, the blade 14 may comprise different lattices 170₁-170_{L} each covering a given one of the toe portion 61, the heel portion 62 and the intermediate portion 63, as shown in FIG. 51. As another example, in some embodiments, the blade 14 may comprise different lattices 170₁, 170₂ the lattice 170₁ defining an upper portion of the blade 14 and the lattice 170₂ defining a lower portion of the blade 14, the lattice 170₂ being lighter but less stiff than the lattice 170₁ in order to facilitate handling (e.g. by increasing vibration damping and diminishing weight of the blade 14) and still increase energy transfer to a hockey puck (e.g. by having a relatively stiff blade 14), as shown in FIG. 52.

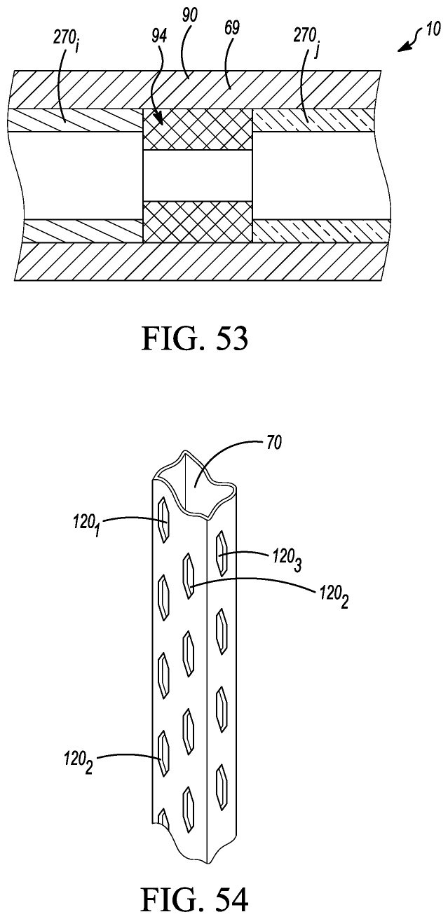

In some embodiments, as shown in FIG. 53, the shaft 12 may comprises lattices 270₁-270_{L} similar to the lattice 70 that are separate from one another. In this example, adjacent ones of the lattices 270₁-270_{L} are spaced from one another by a non-latticed portion 94. The lattices 270₁-270_{L} may be or include distinct zones structurally different from one another, as discussed above. For example, in some embodiments, a lower one of the lattice 270₁-270_{L} may be less stiff or more resilient than a higher one of the lattices 270₁-270_{L} (e.g., to adjust the flex of the hockey stick 10).

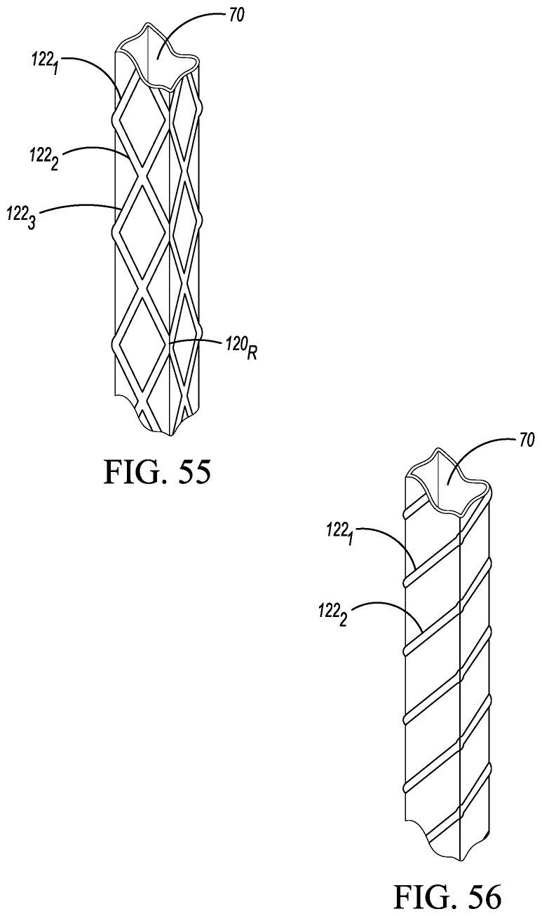

In some embodiments, as shown in FIGS. 54 to 56, the lattice 70 may comprise recesses 120₁-120_{R} and/or ribs 122₁-122_{R} in order to provide a stick 10 which facilitates puck handling, facilitates grip, increases power transmission and/or energy transmission from the hockey stick 10 to the puck during wrist shots and/or slap shots, is light, increases impact resistance of the hockey stick 10, increases elongation at break of the hockey stick 10, is relatively cheap to manufacture, and so on. In some embodiments, a depth of the recesses 120₁-120_{R} and/or ribs 122₁-122_{R} may be insignificant and may improve an appearance and a touch (i.e. a feel) of the stick 10. For example, in some embodiments, the depth of the recesses 120₁-120_{R} and/or ribs 122₁-122_{R} may be no more than 1.5 mm, in some embodiments no more than 1 mm, in some embodiments no more than 0.5 mm and in some embodiments even less. However, in some embodiments, the depth of the recesses 120₁-120_{R} and/or ribs 122₁-122_{R} may be significant and may increase stiffness of the stick 10 and/or reduce weight of the stick 10. For example, in some embodiments, the depth of the recesses 120₁-120_{R} and/or ribs 122₁-122_{R} may be at least 1.5 mm, in some embodiments at least 2 mm, in some embodiments at least 3 mm, in some embodiments at least 4 mm, in some embodiments at least 5 mm, and in some embodiments even more.

Further, in some embodiments, as shown in FIG. 56, the lattice 70 may be anisotropic. For instance, a torsional stiffness of the lattice 70 may be greater in one direction than in another opposite direction. This may allow the stick to be light, yet to resist repetitive impacts when the impacts are expected to be mostly in the same direction. In this embodiment, this is achieved by having the lattice 70 defining rib 122₁, 122₂ which are configured for supporting the lattice 70 when the lattice 70 is subject to torsional stress in one direction but not for supporting the lattice 70 when the lattice 70 is subject to torsional stress in the other opposite direction.

Alternatively, in some embodiments, instead of being formed by the lattice 70, the 120₁-120_{R} and/or ribs 122₁-122_{R} may be formed by the covering 69 around the lattice 70.

In some embodiments, the hockey stick 10 may comprise one or more additively-manufactured components, instead of or in addition to the lattice 70. That is, the lattice 70 is one example of an additively-manufactured component in embodiments where it is 3D-printed. Such one or more additively-manufactured components of the hockey stick 10 may be 3D-printed as discussed above, using any suitable 3D-printing technology, similar to what was discussed above in relation to the lattice 70 in embodiments where the lattice 70 is 3D-printed. The hockey stick 10 may comprise the lattice 70, which may or may not be additively-manufactured, or may not have any lattice in embodiments where the hockey stick 10 comprises such one or more additively-manufactured components.

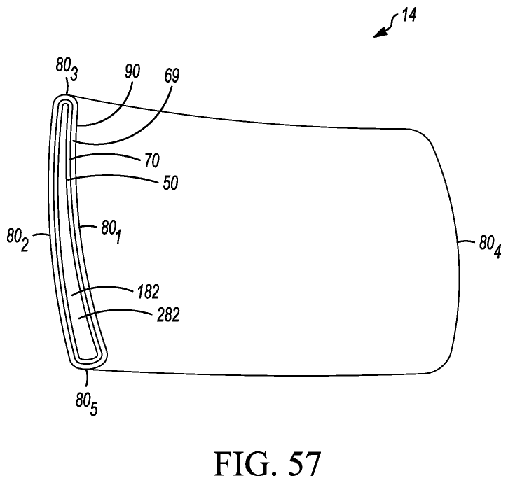

For example, in some embodiments, as shown in FIG. 57, the blade 14 may comprises an additively-manufactured core 182. In this embodiment, the additively-manufactured core 182 comprises a 3D-printed lattice 282 that can be constructed and configured similarly to what is discussed above in relation of the lattice 70, in embodiments where the lattice 70 is 3D-printed.

The 3D-printed lattice 282 of the core 182 of the blade 14 may be manufactured in any suitable way, using any suitable materials and may have any suitable mechanical properties, such as those described with regards to the lattice 70. In this embodiment, the 3D-printed lattice 282 is manufactured prior to the lattice 70, while in other embodiments, the 3D-printed lattice 282 and the lattice 70 are manufactured simultaneously.

In some embodiments, the method of manufacture, the materials and the structure of the lattices 70, 282 forming the blade 14 may differ. For instance, the lattice 282 may be lighter (i.e. less dense) but less stiff than the lattice 70 which is over the lattice 282 and thus may provide stiffness to the blade 14 more efficiently.

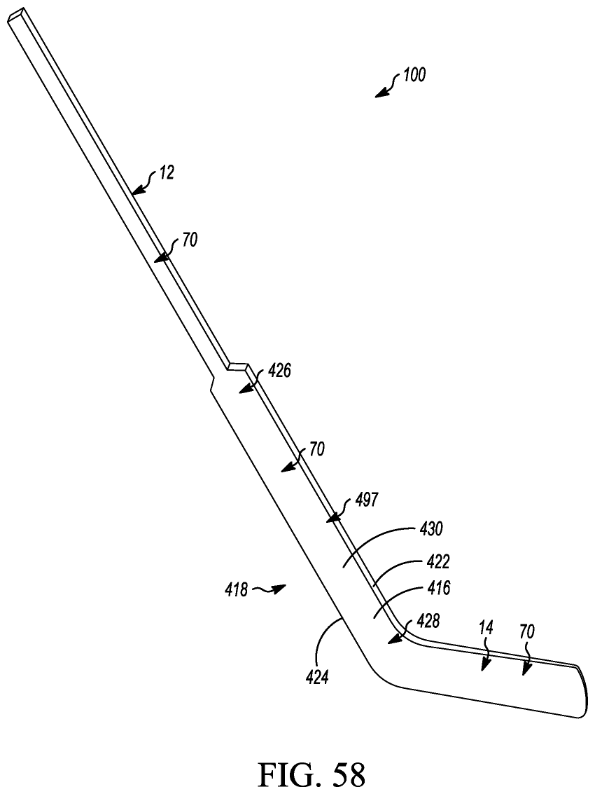

While in this embodiment the hockey stick 10 is a player stick for the user that is a forward, i.e., right wing, left wing, or center, or a defenseman, in other embodiments, as shown in FIG. 58, the hockey stick 10 may be a goalie stick where the user is a goalie. The goalie stick 10 may be constructed according to principles discussed herein. For example, in some embodiments, the goalie stick 10 may comprise the lattice 70 (e.g., which may be additively-manufactured or otherwise made) and/or one or more other additively-manufactured components, as discussed above.

The goalie stick 10 comprises a paddle 497 that may be constructed according to principles discussed herein. For instance, in some embodiments, the paddle 497 may be disposed between the shaft 12 and the blade 14. The paddle 497 is configured to block hockey pucks from flying into the net. A periphery 430 of the paddle 497 includes a front surface 416 and a rear surface 418 opposite one another, as well as a top edge 422 and a bottom edge 424 opposite one another. Proximal and distal end portions 426, 428 of the paddle 497 are spaced apart in a longitudinal direction of the paddle 497, respectively adjacent to the shaft 12 and the blade 14, and define a length of the paddle 497. More particularly, in this embodiment, at least part of the goalie stick 10 is latticed, i.e., comprises the lattice 70. Thus, in this example, the lattice 70 (e.g., which may be additively-manufactured or otherwise made) and/or one or more other additively-manufactured components constitutes at least part of the shaft 12 and/or at least part of the blade 14 and/or at least part of the paddle 497 in a similar fashion as described above with regards to the hockey player stick 10.

Although in this embodiment the sporting implement 10 is a hockey stick, in other embodiments, the sporting implement 10 may be any other implement used for striking, propelling or otherwise moving an object in a sport.

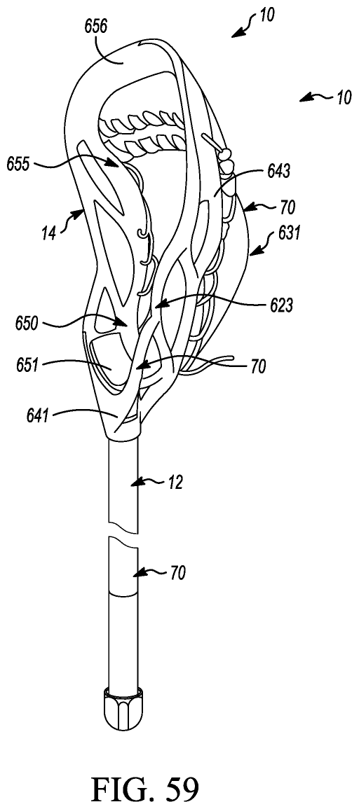

For example, in other embodiments, as shown in FIG. 59, the sporting implement 10 may be a lacrosse stick for a lacrosse player, in which the object-contacting member 14 of the lacrosse stick 10 comprises a lacrosse head for carrying, shooting and passing a lacrosse ball.

The lacrosse head 14 comprises a frame 623 and a pocket 631 connected to the frame 623 and configured to hold the lacrosse ball. The frame 623 includes a base 641 connected to the shaft 12 and a sidewall 643 extending from the base 641. In this embodiment, the sidewall 643 is shaped to form a narrower area 650 including a ball stop 651 adjacent to the base 641 and an enlarged area 655 including a scoop 656 opposite to the base 641. Also, in this embodiment, the pocket 31 includes a mesh 660.

The lacrosse stick 10 may be constructed according to principles discussed herein. For example, in some embodiments, the lacrosse stick 10 may comprise the lattice 70 (e.g., which may be additively-manufactured or otherwise made) and/or one or more other additively-manufactured components, as discussed above. For instance, in some embodiments, the lattice 70 (e.g., which may be additively-manufactured or otherwise made) and/or one or more other additively-manufactured components may constitute at least part of the shaft 12 and/or at least part of the lacrosse head 14, such as at least part of the frame 623 and/or at least part of the pocket 631, according to principles discussed herein.

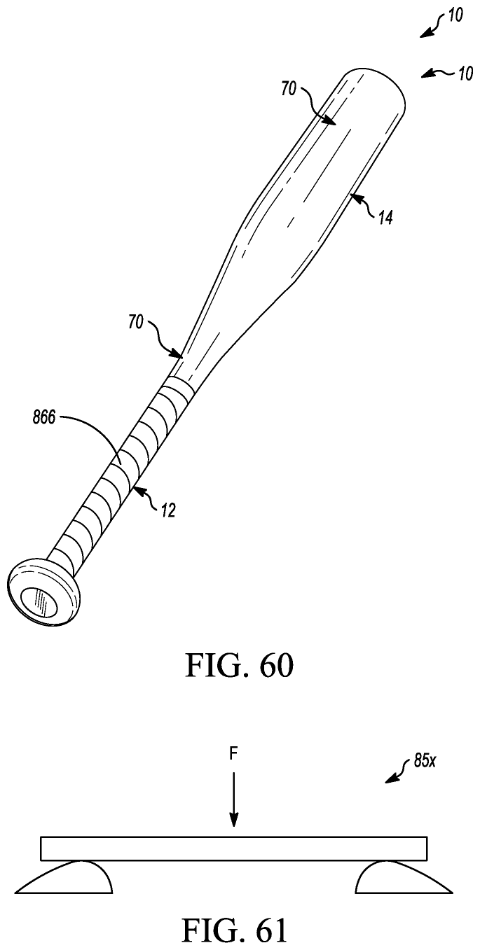

In other embodiments, as shown in FIG. 60, the sporting implement 10 may be a ball bat (e.g., a baseball or softball bat) for a ball player, in which the object-contacting member 14 of the ball bat 10 comprises a barrel for hitting a ball.

The ball bat 10 may be constructed according to principles discussed herein. For example, in some embodiments, the ball bat 10 may comprise the lattice 70 (e.g., which may be additively-manufactured or otherwise made) and/or one or more other additively-manufactured components, as discussed above. For instance, in some embodiments, the lattice 70 (e.g., which may be additively-manufactured or otherwise made) and/or one or more other additively-manufactured components may constitute at least part of a handle 866 of the elongate holdable member 12 and/or at least part of the barrel 14, according to principles discussed herein.

Any feature of any embodiment described herein may be combined with any feature of any other embodiment described herein in some examples of implementation.

Certain additional elements that may be needed for operation of certain embodiments have not been described or illustrated as they are assumed to be within a purview of those of ordinary skill. Moreover, certain embodiments may be free of, may lack and/or may function without any element that is not specifically disclosed herein.

Although various embodiments and examples have been presented, this was for purposes of describing but should not be limiting. Various modifications and enhancements will become apparent to those of ordinary skill and are within a scope of this disclosure.

1. A hockey stick comprising:
a blade; and
a shaft to be held by a user;
wherein the hockey stick comprises a lattice including fiber-reinforced composite material.

2. The hockey stick of claim 1, comprising a covering that covers at least part of the lattice.

3. The hockey stick of claim 2, wherein the covering includes fiber-reinforced composite material.

4. The hockey stick of claim 1, wherein the lattice constitutes at least part of the shaft.

5. The hockey stick of claim 4, wherein the lattice occupies at least a majority of a length of the shaft.

6. The hockey stick of claim 5, wherein the lattice occupies an entirety of the length of the shaft.

7. The hockey stick of claim 1, wherein the lattice constitutes at least part of the blade.

8. The hockey stick of claim 7, wherein the lattice occupies at least a majority of a length of the blade.

9. The hockey stick of claim 8, wherein the lattice occupies an entirety of the length of the blade.

10. The hockey stick of claim 4, wherein the lattice constitutes at least part of the blade.

11. The hockey stick of claim 10, wherein the lattice occupies at least a majority of a length of the shaft and at least a majority of a length of the blade.

12. The hockey stick of claim 11, wherein the lattice occupies an entirety of the length of the shaft and an entirety of the length of the blade.

13. The hockey stick of claim 1, wherein the lattice comprises a framework of elongate members that intersect one another at nodes.

14. The hockey stick of claim 13, wherein the elongate members are arranged in a regular arrangement repeating over the lattice.

15. The hockey stick of claim 1, wherein the lattice includes a truss.

16. The hockey stick of claim 1, wherein the lattice comprises peripheral portions that are part of walls of the hockey stick that define a periphery of at least one of the shaft and the blade.

17. The hockey stick of claim 16, wherein opposite ones of the peripheral portions of the lattice are part of opposite ones of the walls of the hockey stick.

18. The hockey stick of claim 4, wherein the lattice comprises peripheral portions that are part of walls of the shaft that define a periphery of the shaft.

19. The hockey stick of claim 18, wherein opposite ones of the peripheral portions of the lattice are part of opposite ones of the walls of the shaft.

20. The hockey stick of claim 18, wherein a front one of the peripheral portions of the lattice is part of a front one of the walls of the shaft that includes a front surface of the shaft, a rear one of the peripheral portions of the lattice is part of a rear one of the walls of the shaft that includes a rear surface of the surface, a top one of the peripheral portions of the lattice is part of a top one of the walls of the shaft that includes a top surface of the shaft, and a bottom one of the peripheral portions of the lattice is part of a bottom one of the walls of the shaft that includes a bottom surface of the shaft.

21. The hockey stick of claim 7, wherein the lattice comprises peripheral portions that are part of walls of the blade that define a periphery of the blade.

22. The hockey stick of claim 21, wherein opposite ones of the peripheral portions of the lattice are part of opposite ones of the walls of the blade.

23. The hockey stick of claim 21, wherein a front one of the peripheral portions of the lattice is part of a front one of the walls of the blade that includes a front surface of the blade, a rear one of the peripheral portions of the lattice is part of a rear one of the walls of the blade that includes a rear surface of the blade, a top one of the peripheral portions of the lattice is part of a top one of the walls of the blade that includes a top edge of the blade, a toe one of the peripheral of the lattice is part of a toe one of the walls of the blade that includes a toe edge of the blade, a heel one of the peripheral portions of the lattice is part of a heel one of the walls of the blade that includes a heel edge of the blade, and a bottom one of the peripheral portions of the lattice is part of a bottom one of the walls of the blade that includes a bottom edge of the blade.

24. The hockey stick of claim 16, wherein the lattice comprises a void between the peripheral portions of the lattice.

25. The hockey stick of claim 24, comprising a core disposed in the void of the lattice.

26. The hockey stick of claim 25, wherein the core includes foam.

27. The hockey stick of claim 25, wherein the core includes elastomeric material.

28. The hockey stick of claim 25, wherein the core includes a plurality of core members separate from one another.

29. The hockey stick of claim 18, wherein the lattice comprises a void between the peripheral portions of the lattice.

30. The hockey stick of claim 29, comprising a core disposed in the void of the lattice.

31. The hockey stick of claim 30, wherein the core includes foam.

32. The hockey stick of claim 30, wherein the core includes elastomeric material.

33. The hockey stick of claim 30, wherein the core includes a plurality of core members separate from one another.

34. The hockey stick of claim 21, wherein the lattice comprises a void between the peripheral portions of the lattice.

35. The hockey stick of claim 34, comprising a core disposed in the void of the lattice.

36. The hockey stick of claim 35, wherein the core includes foam.

37. The hockey stick of claim 35, wherein the core includes elastomeric material.

38. The hockey stick of claim 35, wherein the core includes a plurality of core members separate from one another.

39. The hockey stick of claim 1, wherein: the fiber-reinforced composite material of the lattice is first fiber-reinforced composite material of the lattice that makes up a first part of the lattice; and the lattice comprises second fiber-reinforced composite material that is different from the first fiber-reinforced composite material of the lattice and makes up a second part of the lattice.

40. The hockey stick of claim 1, wherein a strength of the lattice is at least 1000N.

41. The hockey stick of claim 1, wherein a strength of the lattice is at least 1300N.

42. The hockey stick of claim 13, wherein given ones of the nodes are thicker than respective ones of the elongate members that intersect one another thereat.

43. The hockey stick of claim 13, wherein adjacent ones of the nodes in a first region of the lattice are located closer to one another than adjacent ones of the nodes in a second region of the lattice.

44. The hockey stick of claim 2, wherein the covering covers at least a majority of the lattice.

45. The hockey stick of claim 44, wherein the covering covers an entirety of the lattice.

46. The hockey stick of claim 1, wherein: the fiber-reinforced composite material of the covering is first fiber-reinforced composite material of the covering that makes up a first part of the covering; and the covering comprises second fiber-reinforced composite material that is different from the first fiber-reinforced composite material of the covering and makes up a second part of the covering.

47. The hockey stick of claim 1, wherein: the lattice is an additively-manufactured lattice; and the fiber-reinforced composite material of the lattice is 3D-printed fiber-reinforced composite material.

48. The hockey stick of claim 47, wherein the additively-manufactured lattice is 3D-printed using continuous-fiber 3D printing.

49. The hockey stick of claim 1, wherein at least one fiber of the fiber-reinforced composite material of the lattice extends along at least a majority of a length of the lattice.

50. The hockey stick of claim 49, wherein the at least one fiber of the fiber-reinforced composite material of the lattice extends along an entirety of the length of the lattice.

51. The hockey stick of claim 1, wherein the fiber-reinforced composite material of the lattice comprises pre-impregnated fiber tapes positioned and cured to form the lattice.

52. The hockey stick of claim 3, wherein: the covering is an additively-manufactured covering; and the fiber-reinforced composite material of the covering is 3D-printed fiber-reinforced composite material.

53. The hockey stick of claim 52, wherein the additively-manufactured covering is 3D-printed using continuous-fiber 3D printing.

54. The hockey stick of claim 3, wherein at least one fiber of the fiber-reinforced composite material of the covering extends along at least a majority of a length of the covering.

55. The hockey stick of claim 54, wherein the at least one fiber of the fiber-reinforced composite material of the covering extends along an entirety of the length of the covering.

56. The hockey stick of claim 3, wherein the fiber-reinforced composite material of the covering comprises pre-impregnated fiber tapes positioned and cured to form the covering.

57. The hockey stick of claim 1, wherein the lattice includes a plurality of distinct zones structurally different from one another.

58. The hockey stick of claim 57, wherein the distinct zones of the lattice differ in stiffness.

59. The hockey stick of claim 58, wherein a ratio of the stiffness of a first one of the distinct zones of the lattice over the stiffness of a second one of the distinct zones of the lattice is at least 10%.

60. The hockey stick of claim 58, wherein a ratio of the stiffness of a first one of the distinct zones of the lattice over the stiffness of a second one of the distinct zones of the lattice is at least 40%.

61. The hockey stick of claim 57, wherein the distinct zones of the lattice differ in resilience.

62. The hockey stick of claim 61, wherein a ratio of the resilience of a first one of the distinct zones of the lattice over the resilience of a second one of the distinct zones of the lattice is at least 5%.

63. The hockey stick of claim 61, wherein a ratio of the resilience of a first one of the distinct zones of the lattice over the resilience of a second one of the distinct zones of the lattice is at least 30%.

64. The hockey stick of claim 57, wherein the distinct zones of the lattice include at least three distinct zones.

65. The hockey stick of claim 57, wherein the distinct zones of the lattice are layers of the lattice that are layered on one another.

66. The hockey stick of claim 57, wherein a density of the lattice in a first one of the distinct zones of the lattice is greater than the density of the lattice in a second one of the distinct zones of the lattice.

67. The hockey stick of claim 57, wherein a spacing of elongate members of the lattice in a first one of the distinct zones of the lattice is less than the spacing of elongate members of the lattice in a second one of the distinct zones of the lattice.

68. The hockey stick of claim 57, wherein elongate members of the lattice in a first one of the distinct zones of the lattice are cross-sectionally larger than elongate members of the lattice in a second one of the distinct zones of the lattice.

69. The hockey stick of claim 57, wherein an orientation of elongate members of the lattice in a first one of the distinct zones of the lattice is different from the orientation of elongate members of the lattice in a second one of the distinct zones of the lattice.

70. The hockey stick of claim 57, wherein a material composition of the lattice in a first one of the distinct zones of the lattice is different from the material composition of the lattice in a second one of the distinct zones of the lattice.

71. The hockey stick of claim 1, wherein the hockey stick is a player stick.

72. The hockey stick of claim 1, wherein the hockey stick is a goalie stick comprising a paddle.

73. The hockey stick of claim 72, wherein the lattice constitutes at least part of the paddle.

74. The hockey stick of claim 73, wherein the lattice occupies at least a majority of a length of the paddle.

75. The hockey stick of claim 74, wherein the lattice occupies an entirety of the length of the paddle.

76. The hockey stick of claim 73, wherein a stiffness of the lattice is variable in a longitudinal direction of the paddle.

77. The hockey stick of claim 73, wherein a stiffness of the lattice is variable in a widthwise direction of the paddle.

78. The hockey stick of claim 73, wherein a stiffness of the lattice is variable in a thickness direction of the paddle.

79. A hockey stick comprising:
a blade; and
a shaft to be held by a user;
wherein the hockey stick comprises a lattice including fiber-reinforced composite material and constituting at least part of the blade and at least part of the shaft.

80. A hockey stick comprising:
a blade; and
a shaft to be held by a user;
wherein: the hockey stick comprises a lattice including fiber-reinforced composite material; and a stiffness of the lattice is variable in a longitudinal direction of the hockey stick.

81. A hockey stick comprising:
a blade; and
a shaft to be held by a user;
wherein the hockey stick comprises a lattice and a core disposed within the lattice.

82. A hockey stick comprising:
a blade; and
a shaft to be held by a user;
wherein the hockey stick comprises an additively-manufactured component.

83. The hockey stick of claim 82, wherein the blade comprises at least part of the additively-manufactured component.

84. The hockey stick of claim 83, wherein: the blade includes a periphery and a core; and the core comprises the additively-manufactured component.

85. The hockey stick of claim 83, wherein a stiffness of the additively-manufactured component is variable in a longitudinal direction of the blade.

86. The hockey stick of claim 85, wherein the stiffness of the additively-manufactured component in a heel region of the blade is different from the stiffness of the additively-manufactured component in a toe region of the blade.

87. The hockey stick of claim 83, wherein a stiffness of the additively-manufactured component is variable in a heightwise direction of the blade.

88. The hockey stick of claim 87, wherein the stiffness of the additively-manufactured component in a lower region of the blade is less than the stiffness of the additively-manufactured component in an upper region of the blade.

89. The hockey stick of claim 83, wherein a stiffness of the additively-manufactured component is variable in a thicknesswise direction of the blade.

90. The hockey stick of claim 89, wherein the stiffness of the additively-manufactured component in a front region of the blade is less than the stiffness of the additively-manufactured component in a rear region of the blade.

91. The hockey stick of claim 82, wherein the shaft comprises at least part of the additively-manufactured component.

92. The hockey stick of claim 91, wherein: the shaft includes a periphery and a core; and the core comprises the additively-manufactured component.

93. The hockey stick of claim 91, wherein a stiffness of the additively-manufactured component is variable in a longitudinal direction of the shaft.

94. The hockey stick of claim 93, wherein the stiffness of the additively-manufactured component in a kickpoint region of the shaft is different from the stiffness of the additively-manufactured component in a handle region of the shaft.

95. The hockey stick of claim 91, wherein a stiffness of the additively-manufactured component is variable in a transversal direction of the shaft.

96. The hockey stick of claim 82, wherein the additively-manufactured component includes a lattice.

97. The hockey stick of claim 82, wherein the additively-manufactured component comprises fiber-reinforced composite material.

98. The hockey stick of claim 82, wherein the additively-manufactured component comprises polymeric material.

99. The hockey stick of claim 82, comprising a covering that covers at least part of the additively-manufactured component.

100. The hockey stick of claim 99, wherein the covering includes fiber-reinforced composite material.

101. The hockey stick of claim 83, wherein the additively-manufactured component occupies at least a majority of a length of the blade.

102. The hockey stick of claim 101, wherein the additively-manufactured component occupies an entirety of the length of the blade.

103. The hockey stick of claim 91, wherein the additively-manufactured component occupies at least a majority of a length of the shaft.

104. The hockey stick of claim 103, wherein the additively-manufactured component occupies an entirety of the length of the shaft.

105. The hockey stick of claim 83, wherein the additively-manufactured component occupies at least a majority of a length of the shaft and at least a majority of a length of the blade.

106. The hockey stick of claim 95, wherein the additively-manufactured component occupies an entirety of the length of the shaft and an entirety of the length of the blade.

107. The hockey stick of claim 96, wherein the lattice comprises a framework of elongate members that intersect one another at nodes.

108. The hockey stick of claim 107, wherein the elongate members are arranged in a regular arrangement repeating over the lattice.

109. The hockey stick of claim 96, wherein the lattice includes a truss.

110. The hockey stick of claim 82, wherein the additively-manufactured component comprises peripheral portions that are part of walls of the hockey stick that define a periphery of at least one of the shaft and the blade.

111. The hockey stick of claim 110, wherein opposite ones of the peripheral portions of the additively-manufactured component are part of opposite ones of the walls of the hockey stick.

112. The hockey stick of claim 82, wherein the additively-manufactured component comprises peripheral portions that are part of walls of the shaft that define a periphery of the shaft.

113. The hockey stick of claim 112, wherein opposite ones of the peripheral portions of the additively-manufactured component are part of opposite ones of the walls of the shaft.

114. The hockey stick of claim 112, wherein a front one of the peripheral portions of the additively-manufactured component is part of a front one of the walls of the shaft that includes a front surface of the shaft, a rear one of the peripheral portions of the additively-manufactured component is part of a rear one of the walls of the shaft that includes a rear surface of the surface, a top one of the peripheral portions of the additively-manufactured component is part of a top one of the walls of the shaft that includes a top surface of the shaft, and a bottom one of the peripheral portions of the additively-manufactured component is part of a bottom one of the walls of the shaft that includes a bottom surface of the shaft.

115. The hockey stick of claim 82, wherein the additively-manufactured component comprises peripheral portions that are part of walls of the blade that define a periphery of the blade.

116. The hockey stick of claim 115, wherein opposite ones of the peripheral portions of the additively-manufactured component are part of opposite ones of the walls of the blade.

117. The hockey stick of claim 115, wherein a front one of the peripheral portions of the additively-manufactured component is part of a front one of the walls of the blade that includes a front surface of the blade, a rear one of the peripheral portions of the additively-manufactured component is part of a rear one of the walls of the blade that includes a rear surface of the blade, a top one of the peripheral portions of the additively-manufactured component is part of a top one of the walls of the blade that includes a top edge of the blade, a toe one of the peripheral of the additively-manufactured component is part of a toe one of the walls of the blade that includes a toe edge of the blade, a heel one of the peripheral portions of the additively-manufactured component is part of a heel one of the walls of the blade that includes a heel edge of the blade, and a bottom one of the peripheral portions of the additively-manufactured component is part of a bottom one of the walls of the blade that includes a bottom edge of the blade.

118. The hockey stick of claim 110, wherein the additively-manufactured component comprises a void between the peripheral portions of the additively-manufactured component.

119. The hockey stick of claim 118, comprising a core disposed in the void of the additively-manufactured component.

120. The hockey stick of claim 119, wherein the core includes foam.

121. The hockey stick of claim 119, wherein the core includes elastomeric material.

122. The hockey stick of claim 119, wherein the core includes a plurality of core members separate from one another.

123. The hockey stick of claim 110, wherein the additively-manufactured component comprises a void between the peripheral portions of the additively-manufactured component.

124. The hockey stick of claim 123, comprising a core disposed in the void of the additively-manufactured component.

125. The hockey stick of claim 124, wherein the core includes foam.

126. The hockey stick of claim 124, wherein the core includes elastomeric material.

127. The hockey stick of claim 124, wherein the core includes a plurality of core members separate from one another.

128. The hockey stick of claim 115, wherein the additively-manufactured component comprises a void between the peripheral portions of the additively-manufactured component.

129. The hockey stick of claim 128, comprising a core disposed in the void of the additively-manufactured component.

130. The hockey stick of claim 129, wherein the core includes foam.

131. The hockey stick of claim 129, wherein the core includes elastomeric material.

132. The hockey stick of claim 129, wherein the core includes a plurality of core members separate from one another.

133. The hockey stick of claim 117, wherein given ones of the nodes are thicker than respective ones of the elongate members that intersect one another thereat.

134. The hockey stick of claim 117, wherein adjacent ones of the nodes in a first region of the lattice are located closer to one another than adjacent ones of the nodes in a second region of the lattice.

135. The hockey stick of claim 99, wherein the covering covers at least a majority of the additively-manufactured component.

136. The hockey stick of claim 135, wherein the covering covers an entirety of the additively-manufactured component.

137. The hockey stick of claim 93, wherein the additively-manufactured component comprises 3D-printed fiber-reinforced composite material.

138. The hockey stick of claim 137, wherein the additively-manufactured component is 3D-printed using continuous-fiber 3D printing.

139. The hockey stick of claim 137, wherein at least one fiber of the 3D-printed fiber-reinforced composite material extends along at least a majority of a length of the additively-manufactured component.

140. The hockey stick of claim 139, wherein the at least one fiber of the 3D-printed fiber-reinforced composite material of the additively-manufactured component extends along an entirety of the length of the additively-manufactured component.

141. The hockey stick of claim 99, wherein the covering is an additively-manufactured covering.

142. The hockey stick of claim 141, wherein the covering comprises 3D-printed fiber-reinforced composite material.

143. The hockey stick of claim 142, wherein the covering is 3D-printed using continuous-fiber 3D printing.

144. The hockey stick of claim 142, wherein at least one fiber of the 3D-printed fiber-reinforced composite material of the covering extends along at least a majority of a length of the covering.

145. The hockey stick of claim 144, wherein the at least one fiber of the 3D-printed fiber-reinforced composite material of the covering extends along an entirety of the length of the covering.

146. The hockey stick of claim 82, wherein the additively-manufactured component includes a plurality of distinct zones structurally different from one another.

147. The hockey stick of claim 146, wherein the distinct zones of the additively-manufactured component differ in stiffness.

148. The hockey stick of claim 147, wherein a ratio of the stiffness of a first one of the distinct zones of the additively-manufactured component over the stiffness of a second one of the distinct zones of the additively-manufactured component is at least 10%.

149. The hockey stick of claim 147, wherein a ratio of the stiffness of a first one of the distinct zones of the additively-manufactured component over the stiffness of a second one of the distinct zones of the additively-manufactured component is at least 40%.

150. The hockey stick of claim 146, wherein the distinct zones of the additively-manufactured component differ in resilience.

151. The hockey stick of claim 150, wherein a ratio of the resilience of a first one of the distinct zones of the additively-manufactured component over the resilience of a second one of the distinct zones of the additively-manufactured component is at least 5%.

152. The hockey stick of claim 150, wherein a ratio of the resilience of a first one of the distinct zones of the additively-manufactured component over the resilience of a second one of the distinct zones of the additively-manufactured component is at least 30%.

153. The hockey stick of claim 146, wherein the distinct zones of the additively-manufactured component include at least three distinct zones.

154. The hockey stick of claim 153, wherein the distinct zones of the additively-manufactured component are layers of the additively-manufactured component that are layered on one another.

155. The hockey stick of claim 146, wherein a density of the additively-manufactured component in a first one of the distinct zones of the additively-manufactured component is greater than the density of the additively-manufactured component in a second one of the distinct zones of the additively-manufactured component.

156. The hockey stick of claim 146, wherein: the additively-manufactured component comprises a lattice; and a spacing of elongate members of the lattice in a first one of the distinct zones of the additively-manufactured component is less than the spacing of elongate members of the lattice in a second one of the distinct zones of the additively-manufactured component.

157. The hockey stick of claim 146, wherein: the additively-manufactured component comprises a lattice; and elongate members of the lattice in a first one of the distinct zones of the additively-manufactured component are cross-sectionally larger than elongate members of the lattice in a second one of the distinct zones of the additively-manufactured component.

158. The hockey stick of claim 146, wherein: the additively-manufactured component comprises a lattice; and an orientation of elongate members of the lattice in a first one of the distinct zones of the additively-manufactured component is different from the orientation of elongate members of the lattice in a second one of the distinct zones of the additively-manufactured component.

159. The hockey stick of claim 146, wherein a material composition of the additively-manufactured component in a first one of the distinct zones of the additively-manufactured component is different from the material composition of the additively-manufactured component in a second one of the distinct zones of the additively-manufactured component.

160. The hockey stick of claim 82, comprising a sensor associated with the additively-manufactured component.

161. The hockey stick of claim 82, comprising an actuator, wherein the sensor is responsive to an event to cause the actuator to alter the additively-manufactured component.

162. The hockey stick of claim 82, wherein the additively-manufactured component comprises the sensor.

163. The hockey stick of claim 82, wherein the additively-manufactured component comprises piezoelectric material implementing the sensor.

164. The hockey stick of claim 82, wherein the hockey stick is a player stick.

165. The hockey stick of claim 82, wherein the hockey stick is a goalie stick comprising a paddle.

166. The hockey stick of claim 165, wherein the additively-manufactured component constitutes at least part of the paddle.

167. The hockey stick of claim 166, wherein the additively-manufactured component occupies at least a majority of a length of the paddle.

168. The hockey stick of claim 167, wherein the additively-manufactured component occupies an entirety of the length of the paddle.

169. The hockey stick of claim 166, wherein a stiffness of the additively-manufactured component is variable in a longitudinal direction of the paddle.

170. The hockey stick of claim 166, wherein a stiffness of the additively-manufactured component is variable in a widthwise direction of the paddle.

171. The hockey stick of claim 166, wherein a stiffness of the additively-manufactured component is variable in a thickness direction of the paddle.

172. A hockey stick comprising:
a blade; and
a shaft to be held by a user;
wherein the hockey stick comprises an additively-manufactured component comprising a plurality of distinct zones structurally different from one another.

173. A hockey stick comprising:
a blade; and
a shaft to be held by a user;
wherein the hockey stick comprises a plurality of additively-manufactured components with different functions additively-manufactured integrally with one another.

174. The hockey stick of claim 173, wherein the blade includes a first one of the additively-manufactured components and the shaft includes a second one of the additively-manufactured components.

175. A hockey stick comprising:
a blade; and
a shaft to be held by a user;
wherein the hockey stick comprises an additively-manufactured component and a non-additively-manufactured component received by the additively-manufactured component.

176. The hockey stick of claim 175, wherein the additively-manufactured component comprises a lattice.

177. The hockey stick of claim 176, wherein the non-additively-manufactured component is received within the lattice.

178. The hockey stick of claim 177, wherein the non-additively-manufactured component comprises foam.

179. The hockey stick of claim 177, wherein the non-additively-manufactured component comprises elastomeric material.

180. The hockey stick of claim 175, wherein the non-additively-manufactured component comprises an insert removably mountable to the lattice.

181. A method of making a hockey stick, the hockey stick comprising a blade and a shaft to be held by a user, the method comprising:
providing feedstock; and
additively manufacturing a component of the hockey stick using the feedstock.

182. A lacrosse stick comprising:
a head; and
a shaft to be held by a user;
wherein the lacrosse stick comprises a lattice including fiber-reinforced composite material.

183. The lacrosse stick of claim 182, comprising a covering that covers at least part of the lattice.

184. The lacrosse stick of claim 183, wherein the covering includes fiber-reinforced composite material.

185. The lacrosse stick of claim 182, wherein the lattice constitutes at least part of the shaft.

186. The lacrosse stick of claim 185, wherein the lattice occupies at least a majority of a length of the shaft.

187. The lacrosse stick of claim 186, wherein the lattice occupies an entirety of the length of the shaft.

188. The lacrosse stick of claim 182, wherein the lattice constitutes at least part of the head.

189. The lacrosse stick of claim 188, wherein the lattice occupies at least a majority of a length of the head.

190. The lacrosse stick of claim 189, wherein the lattice occupies an entirety of the length of the head.

191. The lacrosse stick of claim 185, wherein the lattice constitutes at least part of the head.

192. The lacrosse stick of claim 191, wherein the lattice occupies at least a majority of a length of the shaft and at least a majority of a length of the head.

193. The lacrosse stick of claim 192, wherein the lattice occupies an entirety of the length of the shaft and an entirety of the length of the head.

194. The lacrosse stick of claim 182, wherein the lattice comprises a framework of elongate members that intersect one another at nodes.

195. The lacrosse stick of claim 194, wherein the elongate members are arranged in a regular arrangement repeating over the lattice.

196. The lacrosse stick of claim 194, wherein the lattice includes a truss.

197. The lacrosse stick of claim 182, wherein the lattice comprises peripheral portions that are part of walls of the lacrosse stick that define a periphery of at least one of the shaft and the head.

198. The lacrosse stick of claim 197, wherein opposite ones of the peripheral portions of the lattice are part of opposite ones of the walls of the lacrosse stick.

199. The lacrosse stick of claim 185, wherein the lattice comprises peripheral portions that are part of walls of the shaft that define a periphery of the shaft.

200. The lacrosse stick of claim 199, wherein opposite ones of the peripheral portions of the lattice are part of opposite ones of the walls of the shaft.

201. The lacrosse stick of claim 199, wherein a front one of the peripheral portions of the lattice is part of a front one of the walls of the shaft that includes a front surface of the shaft, a rear one of the peripheral portions of the lattice is part of a rear one of the walls of the shaft that includes a rear surface of the surface, a top one of the peripheral portions of the lattice is part of a top one of the walls of the shaft that includes a top surface of the shaft, and a bottom one of the peripheral portions of the lattice is part of a bottom one of the walls of the shaft that includes a bottom surface of the shaft.

202. The lacrosse stick of claim 188, wherein the lattice comprises peripheral portions that are part of walls of the head that define a periphery of the head.

203. The lacrosse stick of claim 202, wherein opposite ones of the peripheral portions of the lattice are part of opposite ones of the walls of the head.

204. The lacrosse stick of claim 197, wherein the lattice comprises a void between the peripheral portions of the lattice.

205. The lacrosse stick of claim 204, comprising a core disposed in the void of the lattice.

206. The lacrosse stick of claim 205, wherein the core includes foam.

207. The lacrosse stick of claim 205, wherein the core includes elastomeric material.

208. The lacrosse stick of claim 205, wherein the core includes a plurality of core members separate from one another.

209. The lacrosse stick of claim 199, wherein the lattice comprises a void between the peripheral portions of the lattice.

210. The lacrosse stick of claim 209, comprising a core disposed in the void of the lattice.

211. The lacrosse stick of claim 210, wherein the core includes foam.

212. The lacrosse stick of claim 210, wherein the core includes elastomeric material.

213. The lacrosse stick of claim 210, wherein the core includes a plurality of core members separate from one another.

214. The lacrosse stick of claim 202, wherein the lattice comprises a void between the peripheral portions of the lattice.

215. The lacrosse stick of claim 214, comprising a core disposed in the void of the lattice.

216. The lacrosse stick of claim 215, wherein the core includes foam.

217. The lacrosse stick of claim 215, wherein the core includes elastomeric material.

218. The lacrosse stick of claim 215, wherein the core includes a plurality of core members separate from one another.

219. The lacrosse stick of claim 182, wherein: the fiber-reinforced composite material of the lattice is first fiber-reinforced composite material of the lattice that makes up a first part of the lattice; and the lattice comprises second fiber-reinforced composite material that is different from the first fiber-reinforced composite material of the lattice and makes up a second part of the lattice.

220. The lacrosse stick of claim 182, wherein a strength of the lattice is at least 1000N.

221. The lacrosse stick of claim 182, wherein a strength of the lattice is at least 1300N.

222. The lacrosse stick of claim 194, wherein given ones of the nodes are thicker than respective ones of the elongate members that intersect one another thereat.

223. The lacrosse stick of claim 194, wherein adjacent ones of the nodes in a first region of the lattice are located closer to one another than adjacent ones of the nodes in a second region of the lattice.

224. The lacrosse stick of claim 183, wherein the covering covers at least a majority of the lattice.

225. The lacrosse stick of claim 224, wherein the covering covers an entirety of the lattice.

226. The lacrosse stick of claim 182, wherein: the fiber-reinforced composite material of the covering is first fiber-reinforced composite material of the covering that makes up a first part of the covering; and the covering comprises second fiber-reinforced composite material that is different from the first fiber-reinforced composite material of the covering and makes up a second part of the covering.

227. The lacrosse stick of claim 182, wherein: the lattice is an additively-manufactured lattice; and the fiber-reinforced composite material of the lattice is 3D-printed fiber-reinforced composite material.

228. The lacrosse stick of claim 227, wherein the additively-manufactured lattice is 3D-printed using continuous-fiber 3D printing.

229. The lacrosse stick of claim 182, wherein at least one fiber of the fiber-reinforced composite material of the lattice extends along at least a majority of a length of the lattice.

230. The lacrosse stick of claim 229, wherein the at least one fiber of the fiber-reinforced composite material of the lattice extends along an entirety of the length of the lattice.

231. The lacrosse stick of claim 182, wherein the fiber-reinforced composite material of the lattice comprises pre-impregnated fiber tapes positioned and cured to form the lattice.

232. The lacrosse stick of claim 184, wherein: the covering is an additively-manufactured covering; and the fiber-reinforced composite material of the covering is 3D-printed fiber-reinforced composite material.

233. The lacrosse stick of claim 232, wherein the additively-manufactured covering is 3D-printed using continuous-fiber 3D printing.

234. The lacrosse stick of claim 233, wherein at least one fiber of the fiber-reinforced composite material of the covering extends along at least a majority of a length of the covering.

235. The lacrosse stick of claim 234, wherein the at least one fiber of the fiber-reinforced composite material of the covering extends along an entirety of the length of the covering.

236. The lacrosse stick of claim 184, wherein the fiber-reinforced composite material of the covering comprises pre-impregnated fiber tapes positioned and cured to form the covering.

237. The lacrosse stick of claim 182, wherein the lattice includes a plurality of distinct zones structurally different from one another.

238. The lacrosse stick of claim 237, wherein the distinct zones of the lattice differ in stiffness.

239. The lacrosse stick of claim 238, wherein a ratio of the stiffness of a first one of the distinct zones of the lattice over the stiffness of a second one of the distinct zones of the lattice is at least 10%.

240. The lacrosse stick of claim 238, wherein a ratio of the stiffness of a first one of the distinct zones of the lattice over the stiffness of a second one of the distinct zones of the lattice is at least 40%.

241. The lacrosse stick of claim 237, wherein the distinct zones of the lattice differ in resilience.

242. The lacrosse stick of claim 241, wherein a ratio of the resilience of a first one of the distinct zones of the lattice over the resilience of a second one of the distinct zones of the lattice is at least 5%.

243. The lacrosse stick of claim 241, wherein a ratio of the resilience of a first one of the distinct zones of the lattice over the resilience of a second one of the distinct zones of the lattice is at least 30%.

244. The lacrosse stick of claim 237, wherein the distinct zones of the lattice include at least three distinct zones.

245. The lacrosse stick of claim 237, wherein the distinct zones of the lattice are layers of the lattice that are layered on one another.

246. The lacrosse stick of claim 237, wherein a density of the lattice in a first one of the distinct zones of the lattice is greater than the density of the lattice in a second one of the distinct zones of the lattice.

247. The lacrosse stick of claim 237, wherein a spacing of elongate members of the lattice in a first one of the distinct zones of the lattice is less than the spacing of elongate members of the lattice in a second one of the distinct zones of the lattice.

248. The lacrosse stick of claim 237, wherein elongate members of the lattice in a first one of the distinct zones of the lattice are cross-sectionally larger than elongate members of the lattice in a second one of the distinct zones of the lattice.

249. The lacrosse stick of claim 237, wherein an orientation of elongate members of the lattice in a first one of the distinct zones of the lattice is different from the orientation of elongate members of the lattice in a second one of the distinct zones of the lattice.

250. The lacrosse stick of claim 237, wherein a material composition of the lattice in a first one of the distinct zones of the lattice is different from the material composition of the lattice in a second one of the distinct zones of the lattice.

251. A lacrosse stick comprising:
a head; and
a shaft to be held by a user;
wherein the lacrosse stick comprises a lattice including fiber-reinforced composite material and constituting at least part of the head and at least part of the shaft.

252. A lacrosse stick comprising:
a head; and
a shaft to be held by a user;
wherein: the lacrosse stick comprises a lattice including fiber-reinforced composite material; and a stiffness of the lattice is variable in a longitudinal direction of the lacrosse stick.

253. A lacrosse stick comprising:
a head; and
a shaft to be held by a user;
wherein the lacrosse stick comprises a lattice and a core disposed within the lattice.

254. A lacrosse stick comprising:
a head; and
a shaft to be held by a user;
wherein the lacrosse stick comprises an additively-manufactured component.

255. The lacrosse stick of claim 254, wherein the head comprises at least part of the additively-manufactured component.

256. The lacrosse stick of claim 255, wherein: the head includes a periphery and a core; and the core comprises the additively-manufactured component.

257. The lacrosse stick of claim 255, wherein a stiffness of the additively-manufactured component is variable in a longitudinal direction of the head.

258. The lacrosse stick of claim 254, wherein a stiffness of the additively-manufactured component is variable in a heightwise direction of the head.

259. The lacrosse stick of claim 258, wherein the stiffness of the additively-manufactured component in a lower region of the head is less than the stiffness of the additively-manufactured component in an upper region of the head.

260. The lacrosse stick of claim 254, wherein a stiffness of the additively-manufactured component is variable in a thicknesswise direction of the head.

261. The lacrosse stick of claim 260, wherein the stiffness of the additively-manufactured component in a front region of the head is less than the stiffness of the additively-manufactured component in a rear region of the head.

262. The lacrosse stick of claim 254, wherein the shaft comprises at least part of the additively-manufactured component.

263. The lacrosse stick of claim 262, wherein: the shaft includes a periphery and a core; and the core comprises the additively-manufactured component.

264. The lacrosse stick of claim 263, wherein a stiffness of the additively-manufactured component is variable in a longitudinal direction of the shaft.

265. The lacrosse stick of claim 264, wherein the stiffness of the additively-manufactured component in a kickpoint region of the shaft is different from the stiffness of the additively-manufactured component in a handle region of the shaft.

266. The lacrosse stick of claim 263, wherein a stiffness of the additively-manufactured component is variable in a transversal direction of the shaft.

267. The lacrosse stick of claim 254, wherein the additively-manufactured component includes a lattice.

268. The lacrosse stick of claim 254, wherein the additively-manufactured component comprises fiber-reinforced composite material.

269. The lacrosse stick of claim 254, wherein the additively-manufactured component comprises polymeric material.

270. The lacrosse stick of claim 254, comprising a covering that covers at least part of the additively-manufactured component.

271. The lacrosse stick of claim 270, wherein the covering includes fiber-reinforced composite material.

272. The lacrosse stick of claim 254, wherein the additively-manufactured component occupies at least a majority of a length of the head.

273. The lacrosse stick of claim 272, wherein the additively-manufactured component occupies an entirety of the length of the head.

274. The lacrosse stick of claim 262, wherein the additively-manufactured component occupies at least a majority of a length of the shaft.

275. The lacrosse stick of claim 274, wherein the additively-manufactured component occupies an entirety of the length of the shaft.

276. The lacrosse stick of claim 254, wherein the additively-manufactured component occupies at least a majority of a length of the shaft and at least a majority of a length of the head.

277. The lacrosse stick of claim 254, wherein the additively-manufactured component occupies an entirety of the length of the shaft and an entirety of the length of the head.

278. The lacrosse stick of claim 267, wherein the lattice comprises a framework of elongate members that intersect one another at nodes.

279. The lacrosse stick of claim 278, wherein the elongate members are arranged in a regular arrangement repeating over the lattice.

280. The lacrosse stick of claim 267, wherein the lattice includes a truss.

281. The lacrosse stick of claim 254, wherein the additively-manufactured component comprises peripheral portions that are part of walls of the lacrosse stick that define a periphery of at least one of the shaft and the head.

282. The lacrosse stick of claim 281, wherein opposite ones of the peripheral portions of the additively-manufactured component are part of opposite ones of the walls of the lacrosse stick.

283. The lacrosse stick of claim 254, wherein the additively-manufactured component comprises peripheral portions that are part of walls of the shaft that define a periphery of the shaft.

284. The lacrosse stick of claim 283, wherein opposite ones of the peripheral portions of the additively-manufactured component are part of opposite ones of the walls of the shaft.

285. The lacrosse stick of claim 283, wherein a front one of the peripheral portions of the additively-manufactured component is part of a front one of the walls of the shaft that includes a front surface of the shaft, a rear one of the peripheral portions of the additively-manufactured component is part of a rear one of the walls of the shaft that includes a rear surface of the surface, a top one of the peripheral portions of the additively-manufactured component is part of a top one of the walls of the shaft that includes a top surface of the shaft, and a bottom one of the peripheral portions of the additively-manufactured component is part of a bottom one of the walls of the shaft that includes a bottom surface of the shaft.

286. The lacrosse stick of claim 254, wherein the additively-manufactured component comprises peripheral portions that are part of walls of the head that define a periphery of the head.

287. The lacrosse stick of claim 286, wherein opposite ones of the peripheral portions of the additively-manufactured component are part of opposite ones of the walls of the head.

288. The lacrosse stick of claim 283, wherein the additively-manufactured component comprises a void between the peripheral portions of the additively-manufactured component.

289. The lacrosse stick of claim 288, comprising a core disposed in the void of the additively-manufactured component.

290. The lacrosse stick of claim 289, wherein the core includes foam.

291. The lacrosse stick of claim 289, wherein the core includes elastomeric material.

292. The lacrosse stick of claim 289, wherein the core includes a plurality of core members separate from one another.

293. The lacrosse stick of claim 283, wherein the additively-manufactured component comprises a void between the peripheral portions of the additively-manufactured component.

294. The lacrosse stick of claim 293, comprising a core disposed in the void of the additively-manufactured component.

295. The lacrosse stick of claim 294, wherein the core includes foam.

296. The lacrosse stick of claim 294, wherein the core includes elastomeric material.

297. The lacrosse stick of claim 294, wherein the core includes a plurality of core members separate from one another.

298. The lacrosse stick of claim 286, wherein the additively-manufactured component comprises a void between the peripheral portions of the additively-manufactured component.

299. The lacrosse stick of claim 298, comprising a core disposed in the void of the additively-manufactured component.

300. The lacrosse stick of claim 299, wherein the core includes foam.

301. The lacrosse stick of claim 299, wherein the core includes elastomeric material.

302. The lacrosse stick of claim 299, wherein the core includes a plurality of core members separate from one another.

303. The lacrosse stick of claim 278, wherein given ones of the nodes are thicker than respective ones of the elongate members that intersect one another thereat.

304. The lacrosse stick of claim 278, wherein adjacent ones of the nodes in a first region of the lattice are located closer to one another than adjacent ones of the nodes in a second region of the lattice.

305. The lacrosse stick of claim 270, wherein the covering covers at least a majority of the additively-manufactured component.

306. The lacrosse stick of claim 305, wherein the covering covers an entirety of the additively-manufactured component.

307. The lacrosse stick of claim 268, wherein the additively-manufactured component comprises 3D-printed fiber-reinforced composite material.

308. The lacrosse stick of claim 307, wherein the additively-manufactured component is 3D-printed using continuous-fiber 3D printing.

309. The lacrosse stick of claim 307, wherein at least one fiber of the 3D-printed fiber-reinforced composite material extends along at least a majority of a length of the additively-manufactured component.

310. The lacrosse stick of claim 309, wherein the at least one fiber of the 3D-printed fiber-reinforced composite material of the additively-manufactured component extends along an entirety of the length of the additively-manufactured component.

311. The lacrosse stick of claim 270, wherein the covering is an additively-manufactured covering.

312. The lacrosse stick of claim 311, wherein the covering comprises 3D-printed fiber-reinforced composite material.

313. The lacrosse stick of claim 312, wherein the covering is 3D-printed using continuous-fiber 3D printing.

314. The lacrosse stick of claim 312, wherein at least one fiber of the 3D-printed fiber-reinforced composite material of the covering extends along at least a majority of a length of the covering.

315. The lacrosse stick of claim 314, wherein the at least one fiber of the 3D-printed fiber-reinforced composite material of the covering extends along an entirety of the length of the covering.

316. The lacrosse stick of claim 254, wherein the additively-manufactured component includes a plurality of distinct zones structurally different from one another.

317. The lacrosse stick of claim 316, wherein the distinct zones of the additively-manufactured component differ in stiffness.

318. The lacrosse stick of claim 317, wherein a ratio of the stiffness of a first one of the distinct zones of the additively-manufactured component over the stiffness of a second one of the distinct zones of the additively-manufactured component is at least 10%.

319. The lacrosse stick of claim 317, wherein a ratio of the stiffness of a first one of the distinct zones of the additively-manufactured component over the stiffness of a second one of the distinct zones of the additively-manufactured component is at least 40%.

320. The lacrosse stick of claim 316, wherein the distinct zones of the additively-manufactured component differ in resilience.

321. The lacrosse stick of claim 320, wherein a ratio of the resilience of a first one of the distinct zones of the additively-manufactured component over the resilience of a second one of the distinct zones of the additively-manufactured component is at least 5%.

322. The lacrosse stick of claim 320, wherein a ratio of the resilience of a first one of the distinct zones of the additively-manufactured component over the resilience of a second one of the distinct zones of the additively-manufactured component is at least 30%.

323. The lacrosse stick of claim 316, wherein the distinct zones of the additively-manufactured component include at least three distinct zones.

324. The lacrosse stick of claim 323, wherein the distinct zones of the additively-manufactured component are layers of the additively-manufactured component that are layered on one another.

325. The lacrosse stick of claim 324, wherein a density of the additively-manufactured component in a first one of the distinct zones of the additively-manufactured component is greater than the density of the additively-manufactured component in a second one of the distinct zones of the additively-manufactured component.

326. The lacrosse stick of claim 324, wherein: the additively-manufactured component comprises a lattice; and a spacing of elongate members of the lattice in a first one of the distinct zones of the additively-manufactured component is less than the spacing of elongate members of the lattice in a second one of the distinct zones of the additively-manufactured component.

327. The lacrosse stick of claim 324, wherein: the additively-manufactured component comprises a lattice; and elongate members of the lattice in a first one of the distinct zones of the additively-manufactured component are cross-sectionally larger than elongate members of the lattice in a second one of the distinct zones of the additively-manufactured component.

328. The lacrosse stick of claim 324, wherein: the additively-manufactured component comprises a lattice; and an orientation of elongate members of the lattice in a first one of the distinct zones of the additively-manufactured component is different from the orientation of elongate members of the lattice in a second one of the distinct zones of the additively-manufactured component.

329. The lacrosse stick of claim 324, wherein a material composition of the additively-manufactured component in a first one of the distinct zones of the additively-manufactured component is different from the material composition of the additively-manufactured component in a second one of the distinct zones of the additively-manufactured component.

330. The lacrosse stick of claim 254, comprising a sensor associated with the additively-manufactured component.

331. The lacrosse stick of claim 330, comprising an actuator, wherein the sensor is responsive to an event to cause the actuator to alter the additively-manufactured component.

332. The lacrosse stick of claim 330, wherein the additively-manufactured component comprises the sensor.

333. The lacrosse stick of claim 330, wherein the additively-manufactured component comprises piezoelectric material implementing the sensor.

334. A lacrosse stick comprising:
a head; and
a shaft to be held by a user;
wherein the lacrosse stick comprises an additively-manufactured component comprising a plurality of distinct zones structurally different from one another.

335. A lacrosse stick comprising:
a head; and
a shaft to be held by a user;
wherein the lacrosse stick comprises a plurality of additively-manufactured components with different functions additively-manufactured integrally with one another.

336. The lacrosse stick of claim 335, wherein the head includes a first one of the additively-manufactured components and the shaft includes a second one of the additively-manufactured components.

337. A lacrosse stick comprising:
a head; and
a shaft to be held by a user;
wherein the lacrosse stick comprises an additively-manufactured component and a non-additively-manufactured component received by the additively-manufactured component.

338. The lacrosse stick of claim 337, wherein the additively-manufactured component comprises a lattice.

339. The lacrosse stick of claim 338, wherein the non-additively-manufactured component is received within the lattice.

340. The lacrosse stick of claim 339, wherein the non-additively-manufactured component comprises foam.

341. The lacrosse stick of claim 339, wherein the non-additively-manufactured component comprises elastomeric material.

342. The lacrosse stick of claim 337, wherein the non-additively-manufactured component comprises an insert removably mountable to the lattice.

343. A method of making a lacrosse stick, the lacrosse stick comprising a head and a shaft to be held by a user, the method comprising:
providing feedstock; and
additively manufacturing a component of the lacrosse stick using the feedstock.

344. A sporting implement comprising:
an elongate holdable member configured to be held by a user; and
an object-contacting member configured to contact an object intended to be moved by the user;
wherein the sporting implement comprises a lattice including fiber-reinforced composite material.

345. The sporting implement of claim 344, comprising a covering that covers at least part of the lattice.

346. The sporting implement of claim 345, wherein the covering includes fiber-reinforced composite material.

347. The sporting implement of claim 344, wherein the lattice constitutes at least part of the elongate holdable member.

348. The sporting implement of claim 347, wherein the lattice occupies at least a majority of a length of the elongate holdable member.

349. The sporting implement of claim 348, wherein the lattice occupies an entirety of the length of the elongate holdable member.

350. The sporting implement of claim 344, wherein the lattice constitutes at least part of the object-contacting member.

351. The sporting implement of claim 350, wherein the lattice occupies at least a majority of a length of the object-contacting member.

352. The sporting implement of claim 351, wherein the lattice occupies an entirety of the length of the object-contacting member.

353. The sporting implement of claim 347, wherein the lattice constitutes at least part of the object-contacting member.

354. The sporting implement of claim 353, wherein the lattice occupies at least a majority of a length of the elongate holdable member and at least a majority of a length of the object-contacting member.

355. The sporting implement of claim 354, wherein the lattice occupies an entirety of the length of the elongate holdable member and an entirety of the length of the object-contacting member.

356. The sporting implement of claim 344, wherein the lattice comprises a framework of elongate members that intersect one another at nodes.

357. The sporting implement of claim 356, wherein the elongate members are arranged in a regular arrangement repeating over the lattice.

358. The sporting implement of claim 344, wherein the lattice includes a truss.

359. The sporting implement of claim 344, wherein the lattice comprises peripheral portions that are part of walls of the sporting implement that define a periphery of at least one of the elongate holdable member and the object-contacting member.

360. The sporting implement of claim 359, wherein opposite ones of the peripheral portions of the lattice are part of opposite ones of the walls of the sporting implement.

361. The sporting implement of claim 347, wherein the lattice comprises peripheral portions that are part of walls of the elongate holdable member that define a periphery of the elongate holdable member.

362. The sporting implement of claim 361, wherein opposite ones of the peripheral portions of the lattice are part of opposite ones of the walls of the elongate holdable member.

363. The sporting implement of claim 361, wherein a front one of the peripheral portions of the lattice is part of a front one of the walls of the elongate holdable member that includes a front surface of the elongate holdable member, a rear one of the peripheral portions of the lattice is part of a rear one of the walls of the elongate holdable member that includes a rear surface of the surface, a top one of the peripheral portions of the lattice is part of a top one of the walls of the elongate holdable member that includes a top surface of the elongate holdable member, and a bottom one of the peripheral portions of the lattice is part of a bottom one of the walls of the elongate holdable member that includes a bottom surface of the elongate holdable member.

364. The sporting implement of claim 350, wherein the lattice comprises peripheral portions that are part of walls of the object-contacting member that define a periphery of the object-contacting member.

365. The sporting implement of claim 364, wherein opposite ones of the peripheral portions of the lattice are part of opposite ones of the walls of the object-contacting member.

366. The sporting implement of claim 364, wherein a front one of the peripheral portions of the lattice is part of a front one of the walls of the object-contacting member that includes a front surface of the object-contacting member, a rear one of the peripheral portions of the lattice is part of a rear one of the walls of the object-contacting member that includes a rear surface of the object-contacting member, a top one of the peripheral portions of the lattice is part of a top one of the walls of the object-contacting member that includes a top edge of the object-contacting member, a toe one of the peripheral of the lattice is part of a toe one of the walls of the object-contacting member that includes a toe edge of the object-contacting member, a heel one of the peripheral portions of the lattice is part of a heel one of the walls of the object-contacting member that includes a heel edge of the object-contacting member, and a bottom one of the peripheral portions of the lattice is part of a bottom one of the walls of the object-contacting member that includes a bottom edge of the object-contacting member.

367. The sporting implement of claim 359, wherein the lattice comprises a void between the peripheral portions of the lattice.

368. The sporting implement of claim 367, comprising a core disposed in the void of the lattice.

369. The sporting implement of claim 368, wherein the core includes foam.

370. The sporting implement of claim 368, wherein the core includes elastomeric material.

371. The sporting implement of claim 368, wherein the core includes a plurality of core members separate from one another.

372. The sporting implement of claim 361, wherein the lattice comprises a void between the peripheral portions of the lattice.

373. The sporting implement of claim 372, comprising a core disposed in the void of the lattice.

374. The sporting implement of claim 373, wherein the core includes foam.

375. The sporting implement of claim 373, wherein the core includes elastomeric material.

376. The sporting implement of claim 373, wherein the core includes a plurality of core members separate from one another.

377. The sporting implement of claim 364, wherein the lattice comprises a void between the peripheral portions of the lattice.

378. The sporting implement of claim 377, comprising a core disposed in the void of the lattice.

379. The sporting implement of claim 378, wherein the core includes foam.

380. The sporting implement of claim 378, wherein the core includes elastomeric material.

381. The sporting implement of claim 378, wherein the core includes a plurality of core members separate from one another.

382. The sporting implement of claim 344, wherein: the fiber-reinforced composite material of the lattice is first fiber-reinforced composite material of the lattice that makes up a first part of the lattice; and the lattice comprises second fiber-reinforced composite material that is different from the first fiber-reinforced composite material of the lattice and makes up a second part of the lattice.

383. The sporting implement of claim 344, wherein a strength of the lattice is at least 1000N.

384. The sporting implement of claim 344, wherein a strength of the lattice is at least 1300N.

385. The sporting implement of claim 356, wherein given ones of the nodes are thicker than respective ones of the elongate members that intersect one another thereat.

386. The sporting implement of claim 356, wherein adjacent ones of the nodes in a first region of the lattice are located closer to one another than adjacent ones of the nodes in a second region of the lattice.

387. The sporting implement of claim 345, wherein the covering covers at least a majority of the lattice.

388. The sporting implement of claim 387, wherein the covering covers an entirety of the lattice.

389. The sporting implement of claim 344, wherein: the fiber-reinforced composite material of the covering is first fiber-reinforced composite material of the covering that makes up a first part of the covering; and the covering comprises second fiber-reinforced composite material that is different from the first fiber-reinforced composite material of the covering and makes up a second part of the covering.

390. The sporting implement of claim 344, wherein: the lattice is an additively-manufactured lattice; and the fiber-reinforced composite material of the lattice is 3D-printed fiber-reinforced composite material.

391. The sporting implement of claim 390, wherein the additively-manufactured lattice is 3D-printed using continuous-fiber 3D printing.

392. The sporting implement of claim 344, wherein at least one fiber of the fiber-reinforced composite material of the lattice extends along at least a majority of a length of the lattice.

393. The sporting implement of claim 392, wherein the at least one fiber of the fiber-reinforced composite material of the lattice extends along an entirety of the length of the lattice.

394. The sporting implement of claim 344, wherein the fiber-reinforced composite material of the lattice comprises pre-impregnated fiber tapes positioned and cured to form the lattice.

395. The sporting implement of claim 346, wherein: the covering is an additively-manufactured covering; and the fiber-reinforced composite material of the covering is 3D-printed fiber-reinforced composite material.

396. The sporting implement of claim 395, wherein the additively-manufactured covering is 3D-printed using continuous-fiber 3D printing.

397. The sporting implement of claim 346, wherein at least one fiber of the fiber-reinforced composite material of the covering extends along at least a majority of a length of the covering.

398. The sporting implement of claim 397, wherein the at least one fiber of the fiber-reinforced composite material of the covering extends along an entirety of the length of the covering.

399. The sporting implement of claim 356, wherein the fiber-reinforced composite material of the covering comprises pre-impregnated fiber tapes positioned and cured to form the covering.

400. The sporting implement of claim 344, wherein the lattice includes a plurality of distinct zones structurally different from one another.

401. The sporting implement of claim 400, wherein the distinct zones of the lattice differ in stiffness.

402. The sporting implement of claim 401, wherein a ratio of the stiffness of a first one of the distinct zones of the lattice over the stiffness of a second one of the distinct zones of the lattice is at least 10%.

403. The sporting implement of claim 401, wherein a ratio of the stiffness of a first one of the distinct zones of the lattice over the stiffness of a second one of the distinct zones of the lattice is at least 40%.

404. The sporting implement of claim 400, wherein the distinct zones of the lattice differ in resilience.

405. The sporting implement of claim 404, wherein a ratio of the resilience of a first one of the distinct zones of the lattice over the resilience of a second one of the distinct zones of the lattice is at least 5%.

406. The sporting implement of claim 404, wherein a ratio of the resilience of a first one of the distinct zones of the lattice over the resilience of a second one of the distinct zones of the lattice is at least 30%.

407. The sporting implement of claim 400, wherein the distinct zones of the lattice include at least three distinct zones.

408. The sporting implement of claim 400, wherein the distinct zones of the lattice are layers of the lattice that are layered on one another.

409. The sporting implement of claim 400, wherein a density of the lattice in a first one of the distinct zones of the lattice is greater than the density of the lattice in a second one of the distinct zones of the lattice.

410. The sporting implement of claim 400, wherein a spacing of elongate members of the lattice in a first one of the distinct zones of the lattice is less than the spacing of elongate members of the lattice in a second one of the distinct zones of the lattice.

411. The sporting implement of claim 400, wherein elongate members of the lattice in a first one of the distinct zones of the lattice are cross-sectionally larger than elongate members of the lattice in a second one of the distinct zones of the lattice.

412. The sporting implement of claim 400, wherein an orientation of elongate members of the lattice in a first one of the distinct zones of the lattice is different from the orientation of elongate members of the lattice in a second one of the distinct zones of the lattice.

413. The sporting implement of claim 400, wherein a material composition of the lattice in a first one of the distinct zones of the lattice is different from the material composition of the lattice in a second one of the distinct zones of the lattice.

414. The sporting implement of claim 344, wherein the sporting implement is a hockey player stick.

415. The sporting implement of claim 344, wherein the sporting implement is a hockey goalie stick comprising a paddle.

416. The sporting implement of claim 415, wherein the lattice constitutes at least part of the paddle.

417. The sporting implement of claim 416, wherein the lattice occupies at least a majority of a length of the paddle.

418. The sporting implement of claim 417, wherein the lattice occupies an entirety of the length of the paddle.

419. The sporting implement of claim 416, wherein a stiffness of the lattice is variable in a longitudinal direction of the paddle.

420. The sporting implement of claim 416, wherein a stiffness of the lattice is variable in a widthwise direction of the paddle.

421. The sporting implement of claim 416, wherein a stiffness of the lattice is variable in a thickness direction of the paddle.

422. A sporting implement comprising:
a object-contacting member; and
a elongate holdable member to be held by a user;
wherein the sporting implement comprises a lattice including fiber-reinforced composite material and constituting at least part of the object-contacting member and at least part of the elongate holdable member.

423. A sporting implement comprising:
a object-contacting member; and
a elongate holdable member to be held by a user;
wherein: the sporting implement comprises a lattice including fiber-reinforced composite material; and a stiffness of the lattice is variable in a longitudinal direction of the sporting implement.

424. A sporting implement comprising:
a object-contacting member; and
a elongate holdable member to be held by a user;
wherein the sporting implement comprises a lattice and a core disposed within the lattice.

425. A sporting implement comprising:
a object-contacting member; and
a elongate holdable member to be held by a user;
wherein the sporting implement comprises an additively-manufactured component.

426. The sporting implement of claim 425, wherein the object-contacting member comprises at least part of the additively-manufactured component.

427. The sporting implement of claim 426, wherein: the object-contacting member includes a periphery and a core; and the core comprises the additively-manufactured component.

428. The sporting implement of claim 426, wherein a stiffness of the additively-manufactured component is variable in a longitudinal direction of the object-contacting member.

429. The sporting implement of claim 428, wherein the stiffness of the additively-manufactured component in a heel region of the object-contacting member is different from the stiffness of the additively-manufactured component in a toe region of the object-contacting member.

430. The sporting implement of claim 426, wherein a stiffness of the additively-manufactured component is variable in a heightwise direction of the object-contacting member.

431. The sporting implement of claim 430, wherein the stiffness of the additively-manufactured component in a lower region of the object-contacting member is less than the stiffness of the additively-manufactured component in an upper region of the object-contacting member.

432. The sporting implement of claim 426, wherein a stiffness of the additively-manufactured component is variable in a thicknesswise direction of the object-contacting member.

433. The sporting implement of claim 432, wherein the stiffness of the additively-manufactured component in a front region of the object-contacting member is less than the stiffness of the additively-manufactured component in a rear region of the object-contacting member.

434. The sporting implement of claim 425, wherein the elongate holdable member comprises at least part of the additively-manufactured component.

435. The sporting implement of claim 434, wherein: the elongate holdable member includes a periphery and a core; and the core comprises the additively-manufactured component.

436. The sporting implement of claim 434, wherein a stiffness of the additively-manufactured component is variable in a longitudinal direction of the elongate holdable member.

437. The sporting implement of claim 436, wherein the stiffness of the additively-manufactured component in a kickpoint region of the elongate holdable member is different from the stiffness of the additively-manufactured component in a handle region of the elongate holdable member.

438. The sporting implement of claim 434, wherein a stiffness of the additively-manufactured component is variable in a transversal direction of the elongate holdable member.

439. The sporting implement of claim 425, wherein the additively-manufactured component includes a lattice.

440. The sporting implement of claim 425, wherein the additively-manufactured component comprises fiber-reinforced composite material.

441. The sporting implement of claim 425, wherein the additively-manufactured component comprises polymeric material.

442. The sporting implement of claim 425, comprising a covering that covers at least part of the additively-manufactured component.

443. The sporting implement of claim 442, wherein the covering includes fiber-reinforced composite material.

444. The sporting implement of claim 426, wherein the additively-manufactured component occupies at least a majority of a length of the object-contacting member.

445. The sporting implement of claim 444, wherein the additively-manufactured component occupies an entirety of the length of the object-contacting member.

446. The sporting implement of claim 434, wherein the additively-manufactured component occupies at least a majority of a length of the elongate holdable member.

447. The sporting implement of claim 446, wherein the additively-manufactured component occupies an entirety of the length of the elongate holdable member.

448. The sporting implement of claim 426, wherein the additively-manufactured component occupies at least a majority of a length of the elongate holdable member and at least a majority of a length of the object-contacting member.

449. The sporting implement of claim 448, wherein the additively-manufactured component occupies an entirety of the length of the elongate holdable member and an entirety of the length of the object-contacting member.

450. The sporting implement of claim 439, wherein the lattice comprises a framework of elongate members that intersect one another at nodes.

451. The sporting implement of claim 450, wherein the elongate members are arranged in a regular arrangement repeating over the lattice.

452. The sporting implement of claim 439, wherein the lattice includes a truss.

453. The sporting implement of claim 425, wherein the additively-manufactured component comprises peripheral portions that are part of walls of the sporting implement that define a periphery of at least one of the elongate holdable member and the object-contacting member.

454. The sporting implement of claim 453, wherein opposite ones of the peripheral portions of the additively-manufactured component are part of opposite ones of the walls of the sporting implement.

455. The sporting implement of claim 425, wherein the additively-manufactured component comprises peripheral portions that are part of walls of the elongate holdable member that define a periphery of the elongate holdable member.

456. The sporting implement of claim 455, wherein opposite ones of the peripheral portions of the additively-manufactured component are part of opposite ones of the walls of the elongate holdable member.

457. The sporting implement of claim 455, wherein a front one of the peripheral portions of the additively-manufactured component is part of a front one of the walls of the elongate holdable member that includes a front surface of the elongate holdable member, a rear one of the peripheral portions of the additively-manufactured component is part of a rear one of the walls of the elongate holdable member that includes a rear surface of the surface, a top one of the peripheral portions of the additively-manufactured component is part of a top one of the walls of the elongate holdable member that includes a top surface of the elongate holdable member, and a bottom one of the peripheral portions of the additively-manufactured component is part of a bottom one of the walls of the elongate holdable member that includes a bottom surface of the elongate holdable member.

458. The sporting implement of claim 425, wherein the additively-manufactured component comprises peripheral portions that are part of walls of the object-contacting member that define a periphery of the object-contacting member.

459. The sporting implement of claim 458, wherein opposite ones of the peripheral portions of the additively-manufactured component are part of opposite ones of the walls of the object-contacting member.

460. The sporting implement of claim 458, wherein a front one of the peripheral portions of the additively-manufactured component is part of a front one of the walls of the object-contacting member that includes a front surface of the object-contacting member, a rear one of the peripheral portions of the additively-manufactured component is part of a rear one of the walls of the object-contacting member that includes a rear surface of the object-contacting member, a top one of the peripheral portions of the additively-manufactured component is part of a top one of the walls of the object-contacting member that includes a top edge of the object-contacting member, a toe one of the peripheral of the additively-manufactured component is part of a toe one of the walls of the object-contacting member that includes a toe edge of the object-contacting member, a heel one of the peripheral portions of the additively-manufactured component is part of a heel one of the walls of the object-contacting member that includes a heel edge of the object-contacting member, and a bottom one of the peripheral portions of the additively-manufactured component is part of a bottom one of the walls of the object-contacting member that includes a bottom edge of the object-contacting member.

461. The sporting implement of claim 453, wherein the additively-manufactured component comprises a void between the peripheral portions of the additively-manufactured component.

462. The sporting implement of claim 461, comprising a core disposed in the void of the additively-manufactured component.

463. The sporting implement of claim 462, wherein the core includes foam.

464. The sporting implement of claim 463, wherein the core includes elastomeric material.

465. The sporting implement of claim 462, wherein the core includes a plurality of core members separate from one another.

466. The sporting implement of claim 453, wherein the additively-manufactured component comprises a void between the peripheral portions of the additively-manufactured component.

467. The sporting implement of claim 466, comprising a core disposed in the void of the additively-manufactured component.

468. The sporting implement of claim 467, wherein the core includes foam.

469. The sporting implement of claim 467, wherein the core includes elastomeric material.

470. The sporting implement of claim 467, wherein the core includes a plurality of core members separate from one another.

471. The sporting implement of claim 458, wherein the additively-manufactured component comprises a void between the peripheral portions of the additively-manufactured component.

472. The sporting implement of claim 471, comprising a core disposed in the void of the additively-manufactured component.

473. The sporting implement of claim 472, wherein the core includes foam.

474. The sporting implement of claim 472, wherein the core includes elastomeric material.

475. The sporting implement of claim 472, wherein the core includes a plurality of core members separate from one another.

476. The sporting implement of claim 450, wherein given ones of the nodes are thicker than respective ones of the elongate members that intersect one another thereat.

477. The sporting implement of claim 450, wherein adjacent ones of the nodes in a first region of the lattice are located closer to one another than adjacent ones of the nodes in a second region of the lattice.

478. The sporting implement of claim 442, wherein the covering covers at least a majority of the additively-manufactured component.

479. The sporting implement of claim 478, wherein the covering covers an entirety of the additively-manufactured component.

480. The sporting implement of claim 436, wherein the additively-manufactured component comprises 3D-printed fiber-reinforced composite material.

481. The sporting implement of claim 480, wherein the additively-manufactured component is 3D-printed using continuous-fiber 3D printing.

482. The sporting implement of claim 480, wherein at least one fiber of the 3D-printed fiber-reinforced composite material extends along at least a majority of a length of the additively-manufactured component.

483. The sporting implement of claim 482, wherein the at least one fiber of the 3D-printed fiber-reinforced composite material of the additively-manufactured component extends along an entirety of the length of the additively-manufactured component.

484. The sporting implement of claim 442, wherein the covering is an additively-manufactured covering.

485. The sporting implement of claim 484, wherein the covering comprises 3D-printed fiber-reinforced composite material.

486. The sporting implement of claim 485, wherein the covering is 3D-printed using continuous-fiber 3D printing.

487. The sporting implement of claim 485, wherein at least one fiber of the 3D-printed fiber-reinforced composite material of the covering extends along at least a majority of a length of the covering.

488. The sporting implement of claim 487, wherein the at least one fiber of the 3D-printed fiber-reinforced composite material of the covering extends along an entirety of the length of the covering.

489. The sporting implement of claim 425, wherein the additively-manufactured component includes a plurality of distinct zones structurally different from one another.

490. The sporting implement of claim 489, wherein the distinct zones of the additively-manufactured component differ in stiffness.

491. The sporting implement of claim 490, wherein a ratio of the stiffness of a first one of the distinct zones of the additively-manufactured component over the stiffness of a second one of the distinct zones of the additively-manufactured component is at least 10%.

492. The sporting implement of claim 490, wherein a ratio of the stiffness of a first one of the distinct zones of the additively-manufactured component over the stiffness of a second one of the distinct zones of the additively-manufactured component is at least 40%.

493. The sporting implement of claim 489, wherein the distinct zones of the additively-manufactured component differ in resilience.

494. The sporting implement of claim 493, wherein a ratio of the resilience of a first one of the distinct zones of the additively-manufactured component over the resilience of a second one of the distinct zones of the additively-manufactured component is at least 5%.

495. The sporting implement of claim 493, wherein a ratio of the resilience of a first one of the distinct zones of the additively-manufactured component over the resilience of a second one of the distinct zones of the additively-manufactured component is at least 30%.

496. The sporting implement of claim 489, wherein the distinct zones of the additively-manufactured component include at least three distinct zones.

497. The sporting implement of claim 496, wherein the distinct zones of the additively-manufactured component are layers of the additively-manufactured component that are layered on one another.

498. The sporting implement of claim 489, wherein a density of the additively-manufactured component in a first one of the distinct zones of the additively-manufactured component is greater than the density of the additively-manufactured component in a second one of the distinct zones of the additively-manufactured component.

499. The sporting implement of claim 489, wherein: the additively-manufactured component comprises a lattice; and a spacing of elongate members of the lattice in a first one of the distinct zones of the additively-manufactured component is less than the spacing of elongate members of the lattice in a second one of the distinct zones of the additively-manufactured component.

500. The sporting implement of claim 489, wherein: the additively-manufactured component comprises a lattice; and elongate members of the lattice in a first one of the distinct zones of the additively-manufactured component are cross-sectionally larger than elongate members of the lattice in a second one of the distinct zones of the additively-manufactured component.

501. The sporting implement of claim 489, wherein: the additively-manufactured component comprises a lattice; and an orientation of elongate members of the lattice in a first one of the distinct zones of the additively-manufactured component is different from the orientation of elongate members of the lattice in a second one of the distinct zones of the additively-manufactured component.

502. The sporting implement of claim 489, wherein a material composition of the additively-manufactured component in a first one of the distinct zones of the additively-manufactured component is different from the material composition of the additively-manufactured component in a second one of the distinct zones of the additively-manufactured component.

503. The sporting implement of claim 425, comprising a sensor associated with the additively-manufactured component.

504. The sporting implement of claim 503, comprising an actuator, wherein the sensor is responsive to an event to cause the actuator to alter the additively-manufactured component.

505. The sporting implement of claim 504, wherein the additively-manufactured component comprises the sensor.

506. The sporting implement of claim 503, wherein the additively-manufactured component comprises piezoelectric material implementing the sensor.

507. The sporting implement of claim 425, wherein the sporting implement is a hockey player stick.

508. The sporting implement of claim 425, wherein the sporting implement is a hockey goalie stick comprising a paddle.

509. The sporting implement of claim 426, wherein the additively-manufactured component constitutes at least part of the paddle.

510. The sporting implement of claim 427, wherein the additively-manufactured component occupies at least a majority of a length of the paddle.

511. The sporting implement of claim 428, wherein the additively-manufactured component occupies an entirety of the length of the paddle.

512. The sporting implement of claim 427, wherein a stiffness of the additively-manufactured component is variable in a longitudinal direction of the paddle.

513. The sporting implement of claim 427, wherein a stiffness of the additively-manufactured component is variable in a widthwise direction of the paddle.

514. The sporting implement of claim 427, wherein a stiffness of the additively-manufactured component is variable in a thickness direction of the paddle.

515. A sporting implement comprising:
a object-contacting member; and
a elongate holdable member to be held by a user;
wherein the sporting implement comprises an additively-manufactured component comprising a plurality of distinct zones structurally different from one another.

516. A sporting implement comprising:
a object-contacting member; and
a elongate holdable member to be held by a user;
wherein the sporting implement comprises a plurality of additively-manufactured components with different functions additively-manufactured integrally with one another.

517. The sporting implement of claim 516, wherein the object-contacting member includes a first one of the additively-manufactured components and the elongate holdable member includes a second one of the additively-manufactured components.

518. A sporting implement comprising:
a object-contacting member; and
a elongate holdable member to be held by a user;
wherein the sporting implement comprises an additively-manufactured component and a non-additively-manufactured component received by the additively-manufactured component.

519. The sporting implement of claim 518, wherein the additively-manufactured component comprises a lattice.

520. The sporting implement of claim 519, wherein the non-additively-manufactured component is received within the lattice.

521. The sporting implement of claim 520, wherein the non-additively-manufactured component comprises foam.

522. The sporting implement of claim 520, wherein the non-additively-manufactured component comprises elastomeric material.

523. The sporting implement of claim 519, wherein the non-additively-manufactured component comprises an insert removably mountable to the lattice.

524. A method of making a sporting implement, the sporting implement comprising a object-contacting member and a elongate holdable member to be held by a user, the method comprising:
providing feedstock; and
additively manufacturing a component of the sporting implement using the feedstock.
